(19) United States
(12) Patent Application Publication
(10) Pub. No.: US 2024/0349162 A1
(43) Pub. Date: Oct. 17, 2024

(54) TECHNIQUE FOR QUALITY OF SERVICE INDICATION AND COMPLIANCE OF APPLICATION DATA UNITS

(71) Applicant: Telefonaktiebolaget LM Ericsson (publ), Stockholm (SE)

(72) Inventors: Du Ho KANG, Sollentuna (SE); Jose Luis PRADAS, Stockholm (SE); Paul SCHLIWA-BERTLING, Ljungsbro (SE); Thorsten LOHMAR, Aachen (DE)

(73) Assignee: Telefonaktiebolaget LM Ericsson (publ), Stockholm (SE)

(21) Appl. No.: 18/682,256

(22) PCT Filed: Aug. 9, 2022
(86) PCT No.: PCT/EP2022/072380

§ 371 Date: Feb. 8, 2024

Related U.S. Application Data
(60) Provisional application No. 63/231,041, filed on Aug. 9, 2021.

(51) Int. Cl. H04W 40/12; H04L 45/302; H04L 47/34

(52) U.S. Cl. CPC H04W 40/12; H04L 45/306; H04L 47/34; H04L 2212/00

(57) ABSTRACT

A technique for forwarding an application data unit, ADU, within a telecommunications system comprising a radio access network, RAN, for transmission to an end terminal through the RAN is disclosed. The transmission of the ADU to the end terminal is subject to a quality of service, QoS, requirement. As to a method aspect of the technique, at least one internet protocol, IP, packet comprising at least one information unit of the ADUIs received. The at least one IP packet further comprises a first information element indicative of a packaging of information units of the ADU into IP packets. The first information element of the received at least one IP packet is read. At least one extended IP packet comprising a second information element indicative of the QoS requirement of the at least one extended IP packet based on the first information element is generated. The at least one extended IP packet further comprises the received at least one IP packet. The at least one extended IP packet is forwarded to the RAN.

### TECHNICAL FIELD

The present disclosure relates to a technique for indicating a quality of service (QoS) of, in particular encrypted, application data units (ADUs).

### BACKGROUND

Extended reality (XR) services comprise advanced consumer services, which require any sort of cloud rendering support by an external data network at low latency due to a closed loop between user actions and cloud re-action through a telecommunications system. The telecommunications system may comprise a radio access network (RAN) according to any one of the Third Generation Partnership Project (3GPP) standards such as Long Term Evolution (LTE) and New Radio (NR).

An existing system, as schematically illustrated in FIG. 7, comprises an XR server 710, which hosts the content and the XR support and is deployed in an external data network such as a public cloud or on-demand cloud computing platform. The XR server 710 connects through a network address translation and/or firewall (NAT/FW) 708, a user plane function (UPF) 706 and a network node (e.g., a gNodeB or briefly gNB) 704 to a user equipment (UE) 702.

A conventional end-to-end (E2E) protocol stack is depicted in FIG. 8. A multimedia protocol such as real-time transport protocol (also denoted as real-time transmission protocol, briefly RTP) layer 802 is deployed on top of quick UDP internet connections (QUIC) layer 804 and user datagram protocol (UDP) layer 806. QUIC 806 is the next generation (NG) protocol, which together with UDP 806 is about to replace the conventional transmission control protocol (TCP) for any sort of media services. The RTP layer 802 may operate on-top-of the QUIC layer 804. Alternatively, the RTP layer 802 may be replaced by something simpler on top of the QUIC layer 804, as QUIC 804 already provides some of the functionality that RTP 802 contains.

The E2E protocol stack of FIG. 8 illustrates the conventional operation layers of a network node (e.g., gNB) 704 and the UPF 706. The operation layers of the network node 704 and the UPF 706 conventionally operate below, and/or at, the internet protocol (IP) layer 808.

E2E encryption is conventionally applied to XR services, e.g., split rendering or View-Point-Dependent (VPD) rendering. Conventionally, the payload of transport protocols, e.g., TCP or UDP 806, are encrypted, so that intermediate network nodes 704 cannot execute a man-in-the-middle attack. However, the encryption also blinds transparent proxy and deep packet inspection (DPI) functions from mobile operators, which are typically looking deep into the payload to derive the correct quality of service (QoS).

FIG. 9 illustrates a conventional relation of an encoded video sequence and IP packets 902. The encoder (e.g., an XR encoder) produces video frames 904-1, 904-2, 904-3, e.g., a frame every 20 milliseconds (ms). For simplicity, an intra-frame (I-Frame)-only sequence is shown.

Each of the video frames 904-1, 904-2, 904-3 is split into N IP packets 902 in FIG. 9, where the number, N, of IP packets 902 is determined by dividing the frame size by the maximal (or maximum, e.g., possible and/or allowed) IP payload size. The maximal IP payload size is conventionally smaller than a network maximum transmission unit (MTU).

Conventionally, the UPF 706 and RAN 704 are not aware of any content of the IP packets 902 and/or of the origin of the IP packets 902 from a specific application data unit (ADU) 904, leading to erroneous scheduling decisions, e.g., preventing the use of an ADU 904 at a UE 706 in case one or more IP packets 902 is not delivered on time.

### SUMMARY

Accordingly, there is a need for a technique that enables a (e.g., 5G) core network (CN) to deliver information to a RAN for efficiently prioritizing IP packets from one application data unit (ADU) for efficient resource allocation and scheduling. Alternatively or in addition there is a need for a technique that mitigates latency of a traffic flow through a telecommunications system between an application server and an end terminal.

As to a first method aspect, a method of forwarding an (e.g., end-to-end, E2E, encrypted) application data unit (ADU, e.g., an E2E ADU) within a telecommunications system comprising a radio access network (RAN) for transmission to an end terminal through the RAN is provided. The transmission of the ADU to the end terminal is subject to a quality of service (QoS) requirement. The method comprises or initiates a step of receiving at least one internet protocol (IP) packet comprising data and/or at least one information unit of the ADU. The at least one IP packet further comprises a first information element indicative of a packaging of data and/or information units of the ADU into IP packets. The method further comprises or initiates the step of reading the first information element of the received at least one IP packet. The method further comprises or initiates the step of generating at least one extended IP packet comprising a second information element indicative of the QoS requirement of the at least one extended IP packet based on the first information element. The at least one extended IP packet further comprises the received at least one IP packet. The method still further comprises or initiates the step of forwarding the at least one extended IP packet to the RAN.

The method of the first method aspect may be performed by a core network (CN) of the telecommunications system, e.g., by a gateway of the CN and/or a user plane function (UPF) of the CN.

The ADU may be generated and/or processed at an application layer of a protocol stack for end-to-end (E2E) encryption, e.g., at an extended reality (XR) server and/or a 5G media streaming for downlink (MSd) access stratum (AS). The application layer may comprise at least one of an advanced video cording and/or high efficiency video coding (AVC/HEVC) layer, a real-time transmission protocol (RTP) layer, and/or a quick UDP internet connections (QUIC) layer.

The ADU may comprise one of more video frames. A video frame may comprise an inline frame (I-frame), a predictive frame (P-frame) and/or a bidirectional frame (B-frame).

The ADU (e.g., the E2E ADU) may be or may comprise an E2E encrypted ADU. Alternatively or in addition, at least a payload of the ADU and/or an information unit of the ADU may be encrypted.

Encrypting may comprise performing a transport layer security (TLS) and/or a data transport layer security (DTLS) encryption.

The RAN may comprise at least one network node (also denoted as base station), and/or the end terminal. The end terminal may comprise a radio device (also denoted as user equipment, UE) and/or an XR device, e.g., comprising a head-mounted display. Alternatively or in addition, the at least one network node and the end terminal may be configured for wireless connection.

The at least one IP packet may be received at a transmission layer of the protocol stack for E2E encryption. The transmission layer may comprise a user data plane (UDP) layer and/or an IP layer.

The first information element may be read at the transmission layer, e.g., at the IP layer. Reading the first information element may also be denoted as parsing the received at least one IP packet as to the first information element and/or as parsing the first information element. Alternatively or in addition, the second information element may be generated and/or the at least one extended IP packet comprising the second information element may be generated at the transport layer, e.g., at the IP layer.

The at least one extended IP packet may be forwarded to lower layers of the protocol stack for E2E encryption, e.g., comprising a Layer 1 (briefly L1) and/or a Layer 2 (briefly L2).

The Layer 2 may comprise at least one of a service data adaptation protocol (SDAP) layer, a packet data convergence protocol (PDCP) layer, a radio link control (RLC) layer, and/or a medium access control (MAC) layer. Alternatively or in addition, the Layer 1 may comprise a physical (PHY) layer.

The application layer may be higher in the protocol stack than the transmission layer. Alternatively or in addition, the transmission layer may be higher in the protocol stack than the Layer 2. Alternatively or in addition, the Layer 2 may be higher in the protocol stack than the Layer 1.

The QoS requirement may depend on a type of data within the (e.g., encrypted) ADU. E.g., a video frame may have a maximal (or maximum) latency, e.g., 20 milliseconds, for delivering the ADU and/or for the ADU arriving at the end terminal as the QoS requirement.

The QoS requirement may comprise a QoS flow identifier (QFI).

The second information element may comprise further information as received in the first information element.

The at least one extended IP packet may be forwarded to at least one network node of the RAN for transmission to the end terminal.

The first information element and/or the second information element may be transparently sent and/or transparently transmitted.

The first information element (e.g., according to the first method aspect) may be comprised in a bit field comprising one or more bits of a header of the received at least one IP packet.

The first information element may be comprised in a header of the received at least one IP packet comprising at least one of a QUIC header, a RTP extension header and an IP extension header.

Alternatively or in addition, the second information element may be comprised in a header of the at least one extended IP packet comprising a GPRS tunneling protocol (GTP) extension header. GPRS may refer to general packet radio service.

At least one information unit (e.g., according to the first method aspect) and/or a payload of the received at least one IP packet may be encrypted.

The payload of the at least one IP packet may comprise data of the ADU. Alternatively or in addition, the data of the ADU may be packaged into information units. Each information unit may be comprised as payload of the at least one IP packet.

The first information element (e.g., according to the first method aspect) may be received without encryption and/or wherein the first information element may be received in clear text.

The received at least one IP packet may comprise one or more unencrypted headers and/or at least one encrypted header. Alternatively or in addition, the encrypted header may be encrypted, e.g., jointly, with the payload.

The method (e.g., according to the first method aspect) may further comprise the step of receiving a message indicative of a presence of the first information element in relation to the at least one IP packet.

The received message (e.g., according to the first method aspect) may be indicative of a location of the first information element within the received at least one IP packet.

The packaging of the information units of the ADU into IP packets (e.g., according to the first method aspect) may comprise at least one of a size of the ADU; an indication of a boundary of the ADU; a start and/or end of the ADU; a number of IP packets comprising information units of the ADU; a time of generating and/or sending the ADU at an application layer of an E2E protocol stack, optionally wherein the E2E protocol stack comprises an E2E encryption protocol stack; a latency requirement of the ADU; a retransmission regulation associated to the ADU; and a periodicity of generating ADUs.

The first information element may comprise at least one timestamp indicative of the packaging of the information units. E.g., the at least one timestamp may be indicative of the start of the ADU and/or the end of the ADU.

The time of generating and/or sending the ADU may comprise a time of generating and/or sending the next (e.g., as planned) ADU.

The packaging of the information units of the ADU (e.g., according to the first method aspect) may be indicative of statistical information comprising at least one of a mean size of ADUs generated and/or sent over a predetermined ADU generation and/or sending time span; a variance of a size of ADUs generated and/or sent over the predetermined ADU generation and/or sending time span; an average bit rate of an encoder; and a refresh rate of the encoder.

The first information element indicative of the statistical information may differ from the first information element indicative of a packaging of a (e.g., specific) ADU.

The statistical information (e.g., according to the first method aspect) may be received out of band. Alternatively or in addition, the statistical information may be received through at least one of a network exposure function (NEF) and a policy control function (PCF).

The packaging of the information units of the ADU (e.g., according to the first method aspect) may be indicative of a provision of discarding the at least one IP packet and/or any further IP packet associated with the ADU if the at least one IP packet and/or any one of the further IP packets is not transmitted to the end terminal within a predetermined latency tolerance time span according to the QoS requirement.

Discarding the at least one IP packet may also be denoted as dropping the at least one IP packet.

The method (e.g., according to the first method aspect) may further comprise a step of receiving a feedback indicative of a reception of the at least one IP packet and/or the ADU by the end terminal.

The method (e.g., according to the first method aspect) may further comprise a step of sending a message indicative of a capability of reading the first information element.

Receiving and reading the first information element may also be denoted as handling the first information element.

The message indicative of the capability of reading the first information element may be sent from a policy control function (PCF) of a core network (CN) of the telecommunications system comprising the RAN, e.g., to the extended reality (XR) server and/or the 5G media streaming for downlink (MSd) access stratum (AS).

The first information element (e.g., according to the first method aspect) may be indicative of a sequence number of the ADU.

The ADU may be split into multiple IP packets. The first information element of each of the multiple IP packets may be indicative of the sequence number of the ADU.

The QoS requirement (e.g., according to the first method aspect) may comprise at least one QoS flow identifier (QFI).

The QFI may differ for different pieces of information comprised in the ADU.

The method (e.g., according to the first method aspect) may further comprise the step of sending a message indicative of a presence of the second information element in relation to the at least one extended IP packet.

The message indicative of the presence of the second information element may be sent using a (e.g., packet data unit, PDU) session management signaling.

The message may comprise an indication of a packet filter configured by a session management function (SMF) of the CN. Alternatively or in addition, the message may be sent through an access and mobility management function (AMF) using a non-access stratum (NAS).

The generating of the at least one extended IP packet (e.g., according to the first method aspect) may comprise encapsulating the received at least one IP packet.

The at least one extended IP packet (e.g., according to the first method aspect) may comprise at least one general packet radio service Tunneling Protocol (GTP) packet.

The method (e.g., according to the first method aspect) may be performed by a core network (CN) of the telecommunications network. The method (e.g., according to the first method aspect) may be performed by a user plane function (UPF) of the CN.

Alternatively or in addition, the method (e.g., according to the first method aspect) may be performed by a gateway of the telecommunications network and/or of the CN of the telecommunications network.

As to a second method aspect, a method of sending an (e.g., E2E encrypted) ADU (e.g., an E2E ADU) to a CN of a telecommunications system comprising a RAN is provided. The transmission of the ADU to the end terminal is subject to a QoS requirement for transmission to an end terminal through the RAN. The method comprises or initiates the step of generating at least one IP packet comprising data and/or at least one information unit of the ADU. The at least one IP packet further comprises a first information element indicative of a packaging of data and/or information units of the ADU into IP packets. The method further comprises or initiates the step of sending the generated at least one IP packet to the CN.

The method of the second method aspect may be performed by an application server (also referred to as an application function, AF), e.g., an extended-reality (XR) server.

The method (e.g., according to the second method aspect) may further comprise the step of receiving a request for a session establishment from the end terminal. The method may further comprise the step of establishing at least one transport session to the end terminal responsive to the received request.

The transport session may comprise a transmission control protocol (TCP) and/or IP.

The method (e.g., according to the second method aspect) may further comprise or initiate the steps of, and/or may comprise any one of the features of, any one of embodiments of the first method aspect, or steps and/or features corresponding thereto. The method (e.g., according to the second method aspect) may comprise any further feature and/or step disclosed within the context of the first method aspect.

The method (e.g., according to the second method aspect) may be performed by an extended reality (XR) server.

As to a third method aspect, a method of transmitting an application data unit (ADU) via a radio access network (RAN) of a telecommunications system to an end terminal is provided. The transmitting of the ADU to the end terminal is subject to a quality of service (QoS) requirement. The method comprises or initiates the step of receiving at least one extended internet protocol (IP) packet. The at least one extended IP packet comprises a second information element indicative of the QoS requirement of the at least one extended IP packet based on a first information element comprised in at least one IP packet. The at least one IP packet is comprised in the at least one extended IP packet. The at least one IP packet comprises at least one information unit of the ADU and the first information element is indicative of a packaging of information units of the ADU into IP packets. The method further comprises or initiates the step of scheduling a transmission opportunity for the at least one IP packet depending on the QoS requirement indicated in the second information element. The transmission opportunity comprises at least one of a time resource and/or a frequency resource of the RAN. The method further comprises or initiates the step of selectively transmitting the at least one IP packet to the end terminal based on the scheduling.

The method of the third method aspect may be performed by the RAN, e.g., by a network node (also referred to as base station) of the RAN.

The selectivity of the transmission may comprise that the at least one IP packet is not scheduled for transmission, e.g., because a latency threshold (also: latency bound or maximum latency) cannot be remained under (or fulfilled) as the QoS requirement.

The method (e.g., according to the third method aspect) may further comprise or initiate the steps of, and/or comprising any one of the features of, any one of embodiments of the first or second method aspect, or steps and/or features corresponding thereto. The method (e.g., according to the third method aspect) may comprise any further feature and/or step disclosed within the context of the first and/or second method aspect.

The method (e.g., according to the third method aspect) may be performed by a network node of the RAN.

As to a device aspect a computer program product comprising program code portions for performing the steps of any one of the first method aspect and/or the second method aspect and/or third method aspect when the computer program product is executed on one or more computing devices, optionally stored on a computer-readable recording medium is provided.

As to a first device aspect a device for forwarding an application data unit (ADU) within a telecommunications system comprising a radio access network (RAN) for transmission to an end terminal through the RAN is provided. The transmission of the ADU to the end terminal is subject to a quality of service (QoS) requirement. The device configured to receive at least one internet protocol (IP) packet comprising at least one information unit of the ADU. The at least one IP packet further comprises a first information element indicative of a packaging of information units of the ADU into IP packets. The device further configured to read the first information element of the received at least one IP packet. The device further configured to generate at least one extended IP packet comprising a second information element indicative of the QoS requirement of the at least one extended IP packet based on the first information element. The at least one extended IP packet further comprises the received at least one IP packet. The device further configured to forward the at least one extended IP packet to the RAN.

The device (e.g., according to the first device aspect) may further configured to perform any of the steps of the first method aspect.

As to a second device a device for sending an application data unit (ADU) to a core network (CN) of a telecommunications system comprising a radio access network (RAN) for transmission to an end terminal through the RAN is provided. The transmission of the ADU to the end terminal is subject to a quality of service (QoS) requirement. The device configured to generate at least one internet protocol (IP) packet comprising at least one information unit of the ADU. The at least one IP packet further comprises a first information element indicative of a packaging of information units of the ADU into IP packets. The device further configured to send the generated at least one IP packet to the CN.

The device (e.g., according to the second device aspect) further configured to perform any of the steps of the second method aspect.

As to a third device aspect a device for transmitting an application data unit (ADU) via a radio access network (RAN) of a telecommunications system to an end terminal is provided. The transmitting of the ADU to the end terminal is subject to a quality of service (QoS) requirement. The device configured to receive at least one extended internet protocol (IP) packet. The at least one extended IP packet comprises a second information element indicative of the QoS requirement of the at least one extended IP packet based on a first information element comprised in at least one IP packet. The at least one IP packet is comprised in the at least one extended IP packet. The at least one IP packet comprises at least one information unit of the ADU and the first information element is indicative of a packaging of information units of the ADU into IP packets. The device further configured to schedule a transmission opportunity for the at least one IP packet depending on the QoS requirement indicated in the second information element. The transmission opportunity comprises at least one of a time resource and/or a frequency resource of the RAN. The device further configured to selectively transmit the at least one IP packet to the end terminal based on the scheduling.

The device (e.g., according to the third device aspect) may further configured to perform any of the steps of the third method aspect.

As to a yet first device aspect a device for forwarding an application data unit (ADU) within a telecommunications system comprising a radio access network (RAN) for transmission to an end terminal through the RAN is provided. The transmission of the ADU to the end terminal is subject to a quality of service (QoS) requirement. The device comprising memory operable to store instructions and processing circuitry operable to execute the instructions, whereby the device is operative to receive at least one internet protocol (IP) packet comprising at least one information unit of the ADU. The at least one IP packet further comprises a first information element indicative of a packaging of information units of the ADU into IP packets. The device is further operable to read the first information element of the received at least one IP packet. The device is further operable to generate at least one extended IP packet comprising a second information element indicative of the QoS requirement of the at least one extended IP packet based on the first information element. The at least one extended IP packet further comprises the received at least one IP packet. The device is further operable to forward the at least one extended IP packet to the RAN.

The device (e.g., according to the first device aspect) may be further operative to perform any of the steps of the first method aspect.

As to a yet second device aspect a device for sending an application data unit (ADU) to a core network (CN) of a telecommunications system comprising a radio access network (RAN) for transmission to an end terminal through the RAN is provided. The transmission of the ADU to the end terminal is subject to a quality of service (QoS) requirement. The device comprising memory operable to store instructions and processing circuitry operable to execute the instructions, whereby the device is operative to generate at least one internet protocol (IP) packet comprising at least one information unit of the ADU. The at least one IP packet further comprises a first information element indicative of a packaging of information units of the ADU into IP packets. The device is further operative to send the generated at least one IP packet to the CN.

The device (e.g., according to the second device aspect) further operative to perform any of the steps of the second method aspect.

As to a yet third device aspect a device for transmitting an application data unit (ADU) via a radio access network (RAN) of a telecommunications system to an end terminal is provided. The transmitting of the ADU to the end terminal is subject to a quality of service (QoS) requirement. The device comprising memory operable to store instructions and processing circuitry operable to execute the instructions, whereby the device is operative to receive at least one extended internet protocol (IP) packet. The at least one extended IP packet comprises a second information element indicative of the QoS requirement of the at least one extended IP packet based on a first information element comprised in at least one IP packet. The at least one IP packet is comprised in the at least one extended IP packet. The at least one IP packet comprises at least one information unit of the ADU and the first information element is indicative of a packaging of information units of the ADU into IP packets. The device is further operative to schedule a transmission opportunity for the at least one IP packet depending on the QoS requirement indicated in the second information element. The transmission opportunity comprises at least one of a time resource and/or a frequency resource of the RAN. The device is further operative to selectively transmit the at least one IP packet to the end terminal based on the scheduling.

The device (e.g., according to the third device aspect) may be further operative to perform any of the steps of the third method aspect.

As to a yet first device aspect a user plane function (UPF), configured to communicate with an extended reality (XR) server and a base station is provided. The UPF comprising a radio interface and processing circuitry configured to execute any of the steps of the first method aspect.

As to a yet second device aspect an extended reality (XR) server configured to communicate with a user plane function (UPF) is provided. The XR server comprising a radio interface and processing circuitry configured to execute any of the steps of the second method aspect.

As to a yet third device aspect a base station configured to communicate with a user plane function (UPF), and a user equipment (UE) is provided. The base station comprising a radio interface and processing circuitry configured to execute any of the steps of the third method aspect.

As to a system aspect a communication system including a host computer comprising processing circuitry configured to provide user data; a communication interface configured to forward user data to a cellular or ad hoc radio network for transmission to a user equipment (UE); and a user plane function (UPF) is provided. The UPF comprises a radio interface and processing circuitry. The processing circuitry of the UPF being configured to execute any of the steps of the first method aspect.

The communication system (e.g., according to the system aspect) may further include the UE.

The communication system (e.g., according to the system aspect) wherein the radio network may further comprise a base station configured to communicate with the UE. The base station may comprise a radio interface and processing circuitry. The processing circuitry of the base station may be configured to execute any of the steps of third method aspect.

The processing circuitry of the host computer (e.g., according to the system aspect) may be configured to execute a host application, thereby providing the user data. The processing circuitry of the UE may be configured to execute a client application associated with the host application.

The host computer (e.g., according to the system aspect) may comprise an extended reality (XR) server configured to execute any of the steps of the second method aspect.

Without limitation, for example in a 3GPP implementation, any end terminal (also denoted as radio device) may be a user equipment (UE).

The technique may be applied in the context of 3GPP New Radio (NR). NR can provide a wide range of QoS levels. Therefore, at least some embodiments of the technique can ensure that the scheduling appropriate for the QoS of the traffic is selected.

The technique may be implemented in accordance with a 3GPP specification, e.g., for 3GPP release 17. The technique may be implemented for 3GPP LTE or 3GPP NR according to a modification of the 3GPP document TS 38.415, version 16.5.0.

Any end terminal (also: radio device) may be a user equipment (UE), e.g., according to a 3GPP specification, and/or a virtual reality (VR) end terminal, e.g. comprising a VR head-set.

The end terminal and the RAN may be wirelessly connected in an uplink (UL) and/or a downlink (DL) through a Uu interface. Alternatively or in addition, the RAN and the CN may be (e.g. wirelessly and/or by wire) connected through an N3 interface and/or an N2 interface. Further alternatively or in addition, the CN and the application server (e.g., the XR server) may be (e.g. wirelessly and/or by wire) connected through an N6 interface.

The end terminal and/or the RAN may form, or may be part of, a radio network, e.g., according to the Third Generation Partnership Project (3GPP) or according to the standard family IEEE 802.11 (Wi-Fi). The first method aspect, the second method aspect and third method aspect may be performed by one or more embodiments of the CN of the telecommunications system comprising the radio network, the application server and the RAN (e.g., a base station), respectively.

The RAN may comprise one or more network nodes (also denoted as base stations), e.g., performing the third method aspect.

Any of the end terminals (also denoted as radio devices) may be a 3GPP user equipment (UE) or a Wi-Fi station (STA). The end terminal (also denoted as radio device) may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more network nodes (also denoted as base stations).

The end terminal (also denoted as radio device) may be wirelessly connected or connectable (e.g., according to a radio resource control, RRC, state or active mode) with at least one network node (also denoted as base station) of the RAN. Alternatively or in addition, the RAN may be connected or connectable wirelessly and/or by wire to the CN of the telecommunications system. Further alternatively or in addition, the application server (e.g., the XR server) may be connected or connectable wirelessly and/or by wire to the CN of the telecommunications system.

The network node (also denoted as base station) may encompass any station that is configured to provide radio access to any of the end terminals (also: radio devices). The base stations may also be referred to as cell, transmission and reception point (TRP), radio access node or access point (AP). The base station may provide a data link to a host computer (e.g., comprising and/or comprised in the application served, for example the XR server) providing the user data to the end terminal (also: radio device) or gathering user data from the end terminal (also: radio device). Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a transport layer (e.g., comprising a transmission control protocol and/or internet protocol, TCP/IP, layer and/or user datagram protocol, UDP, layer) and/or on an application layer (e.g., comprising a quick UDP internet connections, QUIC, layer, a real-time transport protocol, RTP, layer, and/or an advanced video coding and/or high-efficiency video coding, AVC/HEVC, layer) of a protocol stack for the telecommunication.

Alternatively or in addition, any aspect of the technique may be implemented and/or may comprise a (e.g., transparent) transport of an IP packet through a Layer 1 (e.g., comprising a Physical Layer, PHY), a Layer 2 (e.g., comprising a Medium Access Control, MAC, layer, a Radio Link Control, RLC, layer, a packet data convergence protocol, PDCP, layer, and/or service data adaptation protocol, SDAP, layer), and/or a Layer 3 (e.g., comprising a Radio Resource Control, RRC, layer) of a protocol stack for the radio communication.

As to another aspect, a computer program product is provided. The computer program product comprises program code portions for performing any one of the steps of the first, second and/or third method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a device for forwarding an (e.g., E2E encrypted) ADU (e.g., an E2E ADU) within a telecommunications system comprising a RAN for transmission to an end terminal through the RAN, wherein the transmission of the ADU to the end terminal is subject to a QoS requirement, is provided. The device may be configured to perform any one of the steps of the first method aspect.

As to a second device aspect, a device for sending an (e.g., E2E encrypted) ADU (e.g., an E2E ADU) to a CN of a telecommunications system comprising a RAN for transmission to an end terminal through the RAN, wherein the transmission of the ADU to the end terminal is subject to a QoS requirement, is provided. The device may be configured to perform any one of the steps of the second method aspect.

As to a third device aspect, a device for transmitting an (e.g., E2E encrypted) ADU (e.g., an E2E ADU) via a RAN of a telecommunications system to an end terminal, wherein the transmitting of the ADU to the end terminal is subject to a QoS requirement, is provided. The device may be configured to perform any one of the steps of the third method aspect.

As to a further first device aspect, a device for forwarding an (e.g., E2E encrypted) ADU (e.g., an E2E ADU) within a telecommunications system comprising a RAN for transmission to an end terminal through the RAN, wherein the transmission of the ADU to the end terminal is subject to a QoS requirement, is provided. The device comprises processing circuitry (e.g., at least one processor and a memory). Said memory comprises instructions executable by said at least one processor whereby the device is operative to perform any one of the steps of the first method aspect.

As to a further second device aspect, a device for sending an (e.g., E2E encrypted) ADU (e.g., an E2E ADU) to a CN of a telecommunications system comprising a RAN for transmission to an end terminal through the RAN, wherein the transmission of the ADU to the end terminal is subject to a QoS requirement, is provided. The device comprises processing circuitry (e.g., at least one processor and a memory). Said memory comprises instructions executable by said at least one processor whereby the device is operative to perform any one of the steps of the second method aspect.

As to a further third device aspect, a device for transmitting an (e.g., E2E encrypted) ADU (e.g., an E2E ADU) via a RAN of a telecommunications system to an end terminal, wherein the transmitting of the ADU to the end terminal is subject to a QoS requirement, is provided. The device comprises processing circuitry (e.g., at least one processor and a memory). Said memory comprises instructions executable by said at least one processor whereby the device is operative to perform any one of the steps of the third method aspect.

As to a still further first device aspect, a UPF is provided. The UPF is configured to execute any one of the steps of the method according to the first method aspect.

As to a still further second device aspect, an application server, in particular an XR server, is provided. The application server, in particular the XR server, is configured to execute any one of the steps of the method according to the second method aspect.

As to a still further third device aspect, a base station is provided. The base station is configured to execute any one of the steps of the method according to the third method aspect.

As to a still further aspect, a communication system including a host computer is provided. The host computer comprises a processing circuitry configured to provide (e.g., user) data (e.g., one or more information units comprised in one or more ADUs of the application server, in particular the XR server). The host computer further comprises a communication interface configured to forward (e.g., the user) data (e.g., comprising the one or more information units) to a telecommunication network comprising a cellular network (e.g., the RAN and/or the base station) for transmission to a UE. A processing circuitry of the telecommunication network (e.g., the CN, in particular the UPF of the CN) is configured to execute any one of the steps of the first method aspect.

The communication system may further include the UE. Alternatively, or in addition, the cellular network may further include one or more base stations configured for radio communication with the UE and/or to provide a data link between the UE and the host computer using the third method aspect.

The processing circuitry of the host computer may be configured to execute a host application, thereby providing the data (e.g., the user data and/or packages of information units) and/or any host computer functionality described herein. Alternatively, or in addition, the processing circuitry of the UE may be configured to execute a client application associated with the host application.

The host computer may comprise, and/or may be comprised in, the application server (in particular the XR server) configured to executing any one of the steps of the second method aspect.

Any one of the devices, the UE, the base station, the CN, the communication system, or any node or station for embodying the technique, may further include any feature disclosed in the context of the method aspects, and vice versa. Particularly, any one of the units and modules disclosed herein may be configured to perform or initiate one or more of the steps of the method aspects.

### BRIEF DESCRIPTION OF THE DRAWINGS

Further details of embodiments of the technique are described with reference to the enclosed drawings, wherein:

FIG. 1 shows a schematic block diagram of an embodiment of a device for forwarding an (e.g., end-to-end, E2E, and/or encrypted) application data unit (ADU) within a telecommunications system comprising a radio access network (RAN) for transmission to an end terminal through the RAN, wherein the transmission of the ADU to the end terminal is subject to a quality of service (QoS) requirement;

FIG. 2 shows a schematic block diagram of an embodiment of a device for sending an (e.g., end-to-end, E2E, and/or encrypted) ADU to a CN of a telecommunications system comprising a RAN for transmission to an end terminal through the RAN, wherein the transmission of the ADU to the end terminal is subject to a QoS requirement;

FIG. 3 shows a schematic block diagram of an embodiment of a device for transmitting an (e.g., end-to-end, E2E, and/or encrypted) ADU via a RAN of a telecommunications system to an end terminal, wherein the transmitting of the ADU to the end terminal is subject to a QoS requirement;

FIG. 4 shows a flowchart for a method of forwarding an (e.g., end-to-end, E2E, and/or encrypted) ADU to within telecommunications system comprising a RAN for transmission to an end terminal through the RAN, wherein the transmission of the ADU to the end terminal is subject to a QoS requirement, which method may be implementable by the device of FIG. 1;

FIG. 5 shows a flowchart for a method of sending an (e.g., end-to-end, E2E, and/or encrypted) ADU to a CN of a telecommunications system comprising a RAN for transmission to an end terminal through the RAN, wherein the transmission of the ADU to the end terminal is subject to a quality of service QoS requirement, which method may be implementable by the device of FIG. 2;

FIG. 6 shows a flowchart for a method of transmitting an (e.g., end-to-end, E2E, and/or encrypted) ADU via a RAN of a telecommunications system to an end terminal, wherein the transmitting of the ADU to the end terminal is subject to a QoS requirement, which method may be implementable by the device of FIG. 3;

FIG. 7 schematically illustrates a conventional E2E architecture for XR services;

FIG. 8 schematically illustrates a conventional E2E protocol stack comprising encryption of internet protocol (IP) packets at an application layer;

FIG. 9 schematically illustrates an exemplary splitting of an ADU comprising a video frame into IP packets;

FIG. 10 schematically illustrates an E2E protocol stack together with method steps according to the inventive concept;

FIG. 11 schematically illustrates an exemplary distribution of sizes of ADUs comprising video frames, e.g., I-frames, P-frames and/or B-frames;

FIG. 12 schematically illustrates an example of a conventional assignment of a common latency requirement for all IP packets originating from one ADU, which is too late for the last IP packet;

FIG. 13 schematically illustrates an example of an E2E architecture for application, in particular XR, services according to the inventive concept, which may be implementable by the devices of FIGS. 1, 2 and 3;

FIG. 14 schematically illustrates an exemplary flowchart of transmitting an (e.g., end-to-end, E2E, and/or encrypted) ADU from an application server to an end terminal, which may be implementable by combining the methods of FIGS. 4, 5 and 6;

FIG. 15 schematically illustrates an example of splitting an ADU into multiple IP packets, each comprising a first information element;

FIGS. 16A and 16B schematically illustrate an example of an extended IP packet originating from an IP packet at the start and from within the body of an ADU, respectively;

FIG. 17 schematically illustrate examples of positions for including the first information element within an IP packet;

FIG. 18 schematically illustrates an example of a position for including the second information element within an extended IP packet;

FIG. 19 shows a schematic block diagram of a core network (CN), in particular a user plane function (UPF) of the CN, embodying the device of FIG. 1;

FIG. 20 shows a schematic block diagram of an application server, in particular an XR server, embodying the device of FIG. 2;

FIG. 21 shows a schematic block diagram of a radio access network, in particular a network node, embodying the device of FIG. 3;

FIG. 22 schematically illustrates an example telecommunication network connected via an intermediate network to a host computer, which may embody the device of FIG. 2;

FIG. 23 shows a generalized block diagram of a host computer communicating via a base station or radio device functioning as a gateway with a user equipment over a partially wireless connection, wherein the host computer may embody the device of FIG. 2 and the base station may embody the device of FIG. 3; and

FIGS. 24 and 25 show flowcharts for methods implemented in a communication system including a host computer, a base station or radio device functioning as a gateway and a user equipment, wherein the host computer may embody the device of FIG. 2 and the base station may embody the device of FIG. 3.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

FIG. 1 schematically illustrates a block diagram of an embodiment of a device for forwarding an end-to-end (E2E) (e.g., encrypted) application data unit (ADU) within a telecommunications system comprising a radio access network (RAN) for transmission to an end terminal through the RAN, wherein the transmission of the ADU to the end terminal is subject to a quality of service (QoS) requirement. The device is generically referred to by reference sign 100.

The ADU may be referred to as an E2E ADU because the corresponding application layer is located at the respective ends of the communication. Optionally, the ADU is encrypted, further optionally, the encryption is an E2E encryption (e.g., as indicated by referring to the ADU as an E2E encrypted ADU).

The device 100 comprises an internet protocol (IP) packet reception module 104 configured to receive at least one IP packet comprising data and/or at least one information unit of the ADU, wherein the at least one IP packet further comprises a first information element indicative of a packaging of data and/or information units of the ADU into IP packets.

The device 100 further comprises a first information element read out module 106 configured to read the first information element of the received at least one IP packet.

The device 100 further comprises an extended IP packet generation module 108 configured to generate at least one extended IP packet comprising a second information element indicative of the QoS requirement of the at least one extended IP packet based on the first information element, wherein the at least one extended IP packet further comprises the received at least one IP packet.

The device 100 further comprises an extended IP packet forwarding module 110 configured to forward the at least one extended IP packet to the RAN.

Optionally, the device 100 comprises a message reception module 102 that is configured to receive a message indicative of a presence of the first information element in relation to the at least one IP packet.

Any of the modules of the device 100 may be implemented by units configured to provide the corresponding functionality.

The device 100 may also be referred to as, or may be embodied by, the core network (CN), in particular a user plane function (UPF), of the telecommunications system. The device 100 and an application server (e.g., an extended reality, XR, server) and/or the RAN, e.g., comprising at least one network node (also denoted as base station) may be in direct, e.g. wired and/or radio, communication, e.g., at least for the reception of the IP packet from the application server (e.g., the XR server) at the device 100 and/or the forwarding of the extended IP packet from the device 100 to the RAN, in particular to the at least one network node.

The application server, in particular the XR server, may embody a device 200. Alternatively or in addition, the network node may embody a device 300.

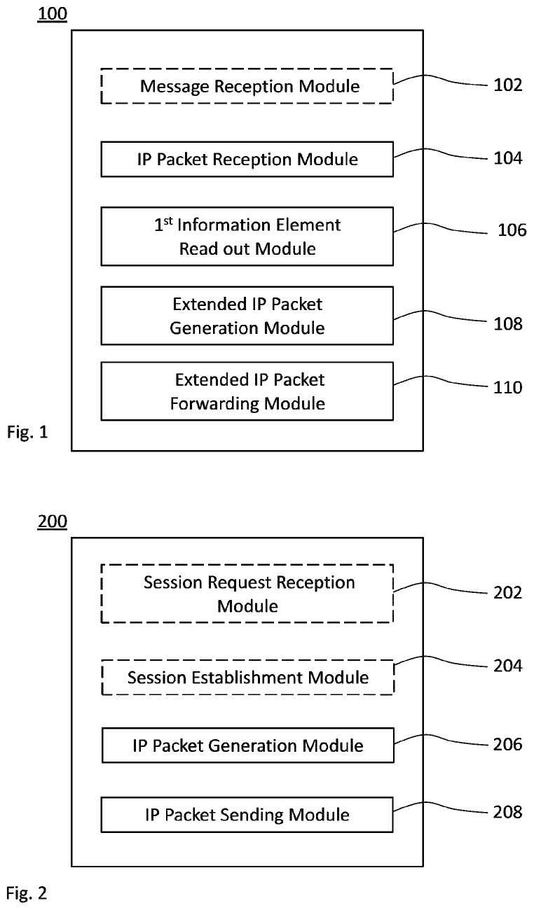

FIG. 2 schematically illustrates a block diagram of an embodiment of a device for sending an E2E (e.g., encrypted) ADU to a CN of a telecommunications system comprising a RAN for transmission to an end terminal through the RAN, wherein the transmission of the ADU to the end terminal is subject to a QoS requirement. The device is generically referred to by reference sign 200.

The device 200 comprises an IP packet generation module 206 that is configured to generate at least one IP packet comprising data and/or at least one information unit of the ADU, wherein the at least one IP packet further comprises a first information element indicative of a packaging of data and/or information units of the ADU into IP packets.

The device 200 further comprises an IP packet sending module 208 that is configured to send the generated at least one IP packet to the CN.

Optionally, the device 200 comprises a session request reception module 202 that is configured to receive a request for a session establishment from the end terminal.

Further optionally, the device 200 comprises a session establishment module 204 that is configured to establish at least one transport session to the end terminal responsive to the received request.

Any of the modules of the device 200 may be implemented by units configured to provide the corresponding functionality.

The device 200 may also be referred to as, or may be embodied by, the application server, in particular the XR server. The CN, in particular the UPF, and the device 200 may be in direct radio and/or wired communication, e.g., at least for the sending of the at least one IP packet. The CN, in particular the UPF, may be embodied by the device 100.

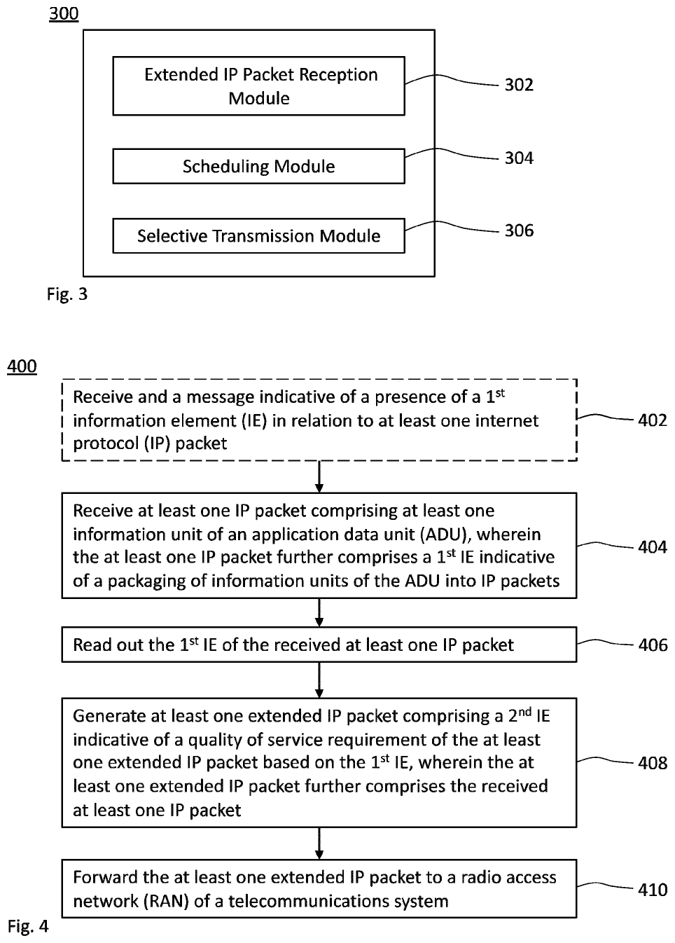

FIG. 3 schematically illustrates a block diagram of an embodiment of a device for transmitting an E2E (e.g., encrypted) ADU via a RAN of a telecommunications system to an end terminal, wherein the transmitting of the ADU to the end terminal is subject to a QoS requirement. The device is generally referred to by reference sign 300.

The device 300 comprises an extended IP packet reception module 302 that is configured to receive at least one extended IP packet. The at least one extended IP packet comprises a second information element indicative of the QoS requirement of the at least one extended IP packet based on a first information element comprised in at least one IP packet. The at least one IP packet is comprised in the at least one extended IP packet. The at least one IP packet comprises data and/or at least one information unit of the ADU. The first information element is indicative of a packaging of data and/or information units of the ADU into IP packets.

The device 300 further comprises a scheduling module 304 that is configured to schedule a transmission opportunity for the at least one IP packet depending on the QoS requirement indicated in the second information element. The transmission opportunity comprises at least one time resource and/or at least one frequency resource of the RAN.

The device 300 further comprises a selective transmission module 306 that is configured to selectively transmit the at least one IP packet to the end terminal based on the scheduling.

Any of the modules of the device 300 may be implemented by units configured to provide the corresponding functionality.

The device 300 may also be referred to as, or may be embodied by, the RAN (e.g., by a network node and/or base station of the RAN). The RAN and the device 100 may be in direct radio and/or wired communication, e.g., at least for the reception of the extended IP packet from the CN (e.g., the UPF) at the device 300. The CN (e.g., the UPF) may be embodied by the device 100.

FIG. 4 shows an example flowchart for a method 400 of forwarding an E2E (e.g., encrypted) ADU within a telecommunications system comprising a RAN for transmission to an end terminal through the RAN, wherein the transmission of the ADU to the end terminal is subject to a QoS requirement.

In a step 404, at least one IP packet comprising data and/or at least one information unit of the ADU is received. The at least one IP packet further comprises a first information element indicative of a packaging of data and/or information units of the ADU into IP packets. In a step 406, the first information element of the received 404 at least one IP packet is read (also denoted as “parsed”). In a step 408, at least one extended IP packet comprising a second information element indicative of the QoS requirement of the at least one extended IP packet is generated based on the first information element, e.g., as read in the step 406. The at least one extended IP packet further comprises the received 404 at least one IP packet. In a step 410, the at least one extended IP packet is forwarded to the RAN.

Optionally, in a step 402, a message indicative of a presence of the first information element in relation to the at least one IP packet is received.

The method 400 may be performed by the device 100. For example, the modules 102, 104, 106, 108 and 110 may perform the steps 402, 404, 406, 408 and 410, respectively.

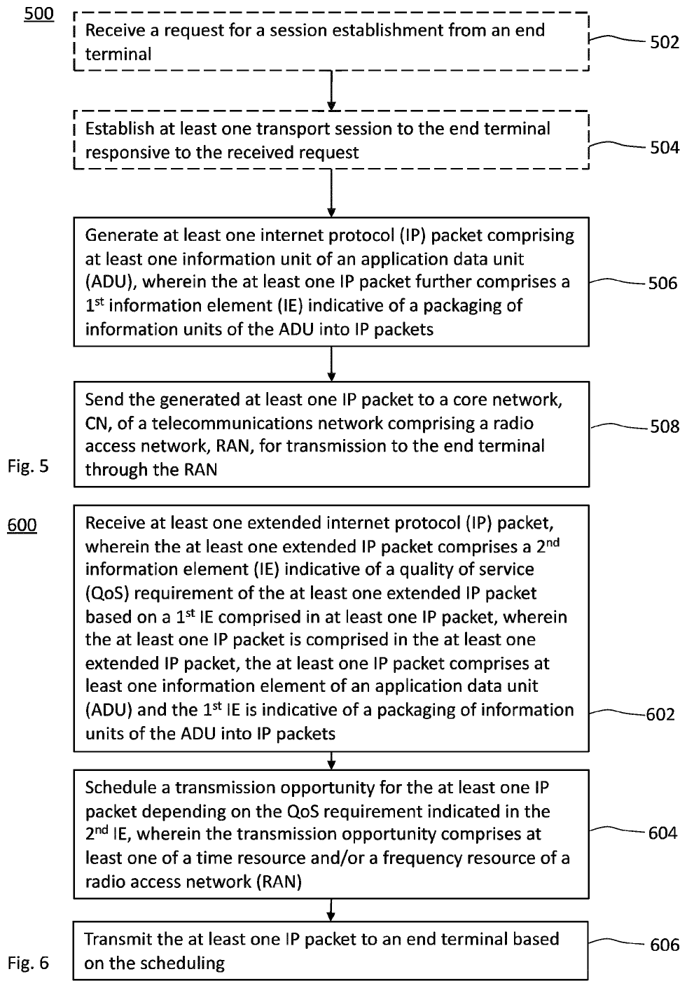

FIG. 5 shows an example flowchart for a method 500 of sending an E2E (e.g., encrypted) ADU to a CN of a telecommunications system comprising a RAN for transmission to an end terminal through the RAN, wherein the transmission of the ADU to the end terminal is subject to a QoS requirement.

In a step 506, at least one IP packet comprising data and/or at least one information unit of the ADU is generated. The at least one IP packet further comprises a first information element indicative of a packaging of data and/or information units of the ADU into IP packets. In a step 508, the generated 506 at least one IP packet is sent to the CN.

Optionally, in a step 502, a request for a session establishment is received from the end terminal. Further optionally, in a step 504 at least one transport session to the end terminal is established responsive to the received 502 request.

The method 500 may be performed by the device 200. For example, the modules 202, 204, 206 and 208 may perform the steps 502, 504, 506 and 508, respectively.

FIG. 6 shows an example flowchart for a method 600 of transmitting an E2E (e.g., encrypted) ADU via a RAN of a telecommunications system to an end terminal, wherein the transmitting of the ADU to the end terminal is subject to a QoS, requirement.

In a step 602, at least one extended IP packet is received. The at least one extended IP packet comprises a second information element indicative of the QoS requirement of the at least one extended IP packet based on a first information element comprised in at least one IP packet. The at least one IP packet is comprised in the at least one extended IP packet. The at least one IP packet comprises data and/or at least one information unit of the ADU. The first information element is indicative of a packaging of data and/or information units of the ADU into IP packets.

In a step 604, a transmission opportunity for the at least one IP packet is scheduled depending on the QoS requirement indicated in the second information element. The transmission opportunity comprises at least one time resource and/or at least one frequency resource of the RAN. In a step 606, the at least one IP packet is selectively transmitted to the end terminal based on the scheduling 604.

The method 600 may be performed by the device 300. For example, the modules 302, 304 and 306 may perform the steps 602, 604 and 606, respectively.

In any aspect, the (e.g., XR) ADU (e.g., a protocol data unit, PDU, from an application layer) may provide information to the CN (e.g., to a gateway of the CN and/or to the UPF) to enable the RAN to optimize radio resource allocation. The first information element may provide means for the (e.g., XR) application server to inform the (e.g., 5G) CN (e.g., 5GC) that is used to configure the UPF so that the UPF understands and utilizes the information when receiving IP packets that constitute and/or originate from (e.g., XR) ADUs and/or from (e.g., XR) frames, e.g., for generating the second information element.

The terminology of application protocol data unit (e.g., application PDU) and ADU may be used indistinctly and/or may be used interchangeably.

The application layer provides a (e.g., XR video) frame and/or (e.g., XR video) ADU and (e.g., QoS) requirement information for the (e.g., 5G) CN and RAN, e.g., by means of the first information element. The information may be transparently delivered through intermediate layers before the IP layer. The UPF interface in the (e.g., 5G) CN can extract relevant application information to signal to the RAN, e.g., by means of the second information element.

According to the invention, a novel set of signaling headers (e.g., comprising the first information element and/or the second information element) may be introduced into the user-plane traffic, so that the UPF can parse out the essential (e.g., with regard to a QoS requirement) application information (e.g., comprised in the first information element and/or the second information element) in a simple way, even when the application traffic is E2E encrypted, e.g., transport layer security (TLS) and/or data transport layer security (DTLS) encrypted.

The application information (e.g., comprising the first information element and/or the second information element) can beneficially optimize (e.g., XR) application related traffic. Alternatively or in addition, the application information (e.g., comprising the first information element and/or the second information element) can be beneficial for a variety of use cases and traffic types, in particular in combination with encryption at a high layer in a protocol stack.

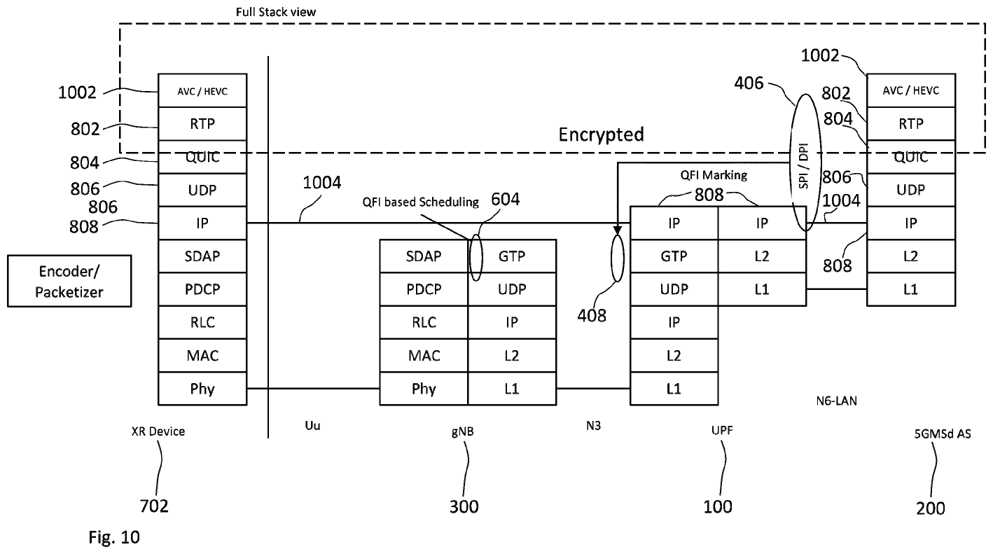

FIG. 10 shows an exemplary (e.g., 5G) protocol stack for E2E delivery of ADUs (e.g., comprising video frames) in an application (e.g., XR) service (e.g., provided by the device 200) according to the inventive concept. Alternatively or in addition, the application server 200 may be denoted as Media streaming for downlink (MSd) and/or MSd access stratum (AS).

From an application perspective, there may be multiple layers to reach the IP layer 808. E.g., the advanced video coding and/or high efficiency video coding (AVC/HEVC) layer 902, RTP layer 802, QUIC layer 804, and/or UDP layer 806, any of which may be transparent to the IP layer 808, may deliver information of applications which are needed for the (e.g., 5G) CN (e.g., comprising the UPF at reference sign 100) and the RAN (e.g., comprising one or more network nodes at reference sign 300).

The application layer may comprise the AVC/HEVC layer 902, RTP layer 802, and/or QUIC layer 804. Alternatively or in addition, the transport layer may comprise the UDP layer 806 and/or IP layer 808.

A transparent transport of IP packet information, e.g., from the application server 200 through the UPF 100 to the end terminal 702, is exemplified at reference sign 1004.

When IP packets arrive at the (e.g., 5G) CN in the direction towards the end terminal 702 (e.g., a wireless device and/or XR device), the UPF interface 100 adds header information (e.g., comprising the second information element) to deliver the packets to RAN (e.g., network node 300) with additional core information, e.g., QoS flow identity (QFI) marking. E.g., at reference sign 406, deep packet inspection (DPI) and/or stateful packet inspection (SPI) is performed.

At reference sign 408, based on the first information element, at the device 100 the second information element is generated and included in an extended IP packet, which comprises the IP packet. The second information element may, e.g., comprise the QFI marking.

The second information element, e.g., comprising the QFI marking, is read by the device 300 (e.g., at a network node of the RAN), and scheduling is performed at reference sign 604 based on the content of the second information element, e.g., the QFI marking.

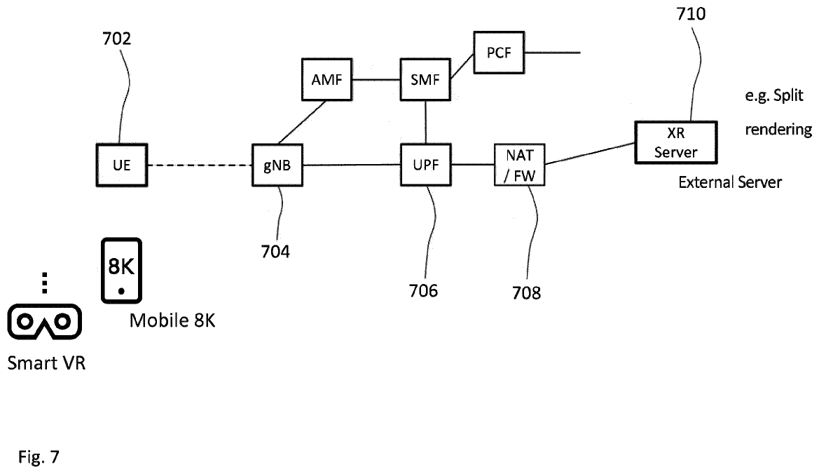

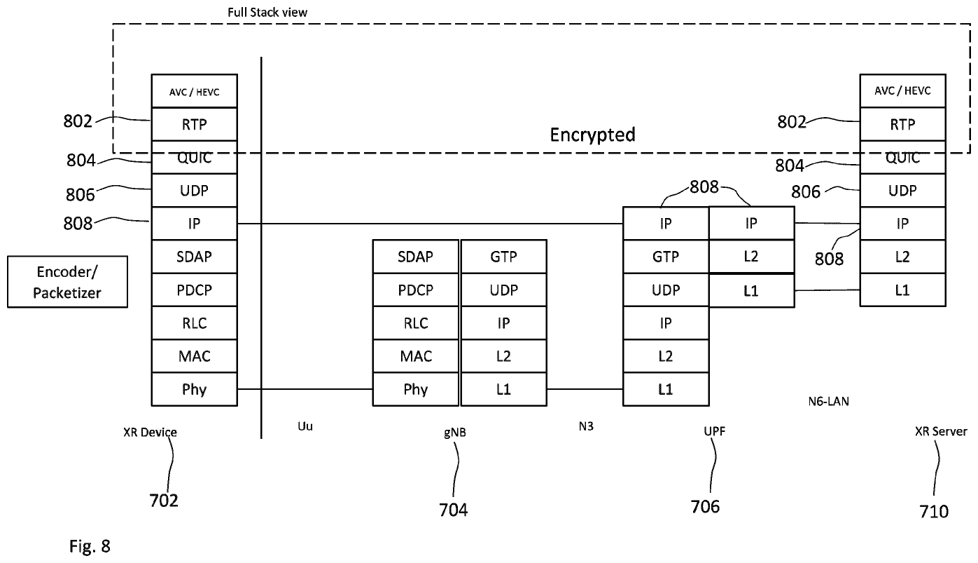

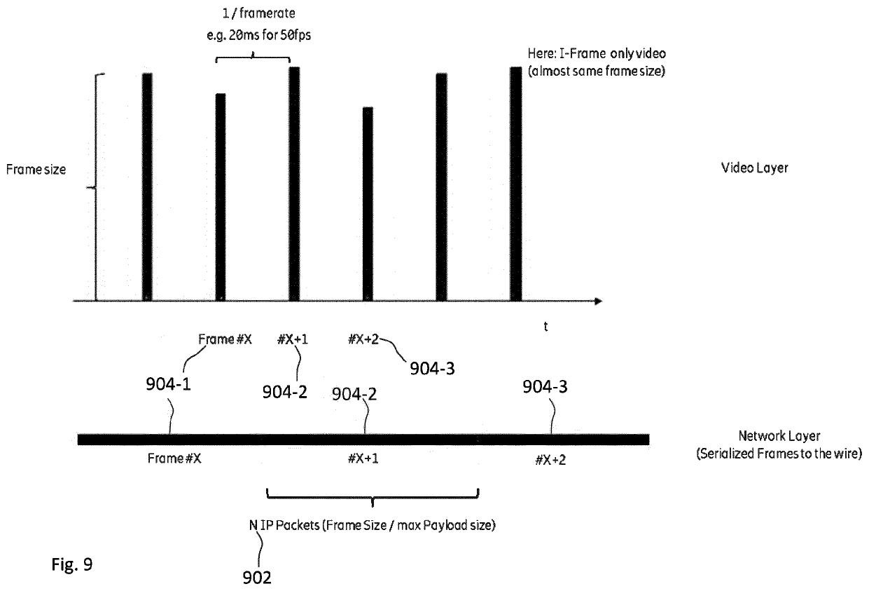

Conventionally, low-latency XR services cannot be supported due to a lack of application information at the 5G CN, e.g., at the UPF 706 in FIGS. 7 and 8. The lack of support is due to the E2E encryption at higher layers, e.g., comprising AVC/HEVC 1002, RTP 802, QUIC 804 and/or UDP 806. Compared to other low-latency services such as Voice-over-Internet-Protocol (VoIP) and industrial traffic with Ultra-Reliable Low Latency Communication (URLLC) requirements, XR may have a much larger ADU size. Hence, for XR services commonly there may be multiple IP packets from one ADU (also denoted as application PDU).

In case of split rendering XR services (e.g., the cloud XR server 720 and/or device 200 crops the correct view-port out of a 360° gaming scene and encodes the resulting view-point using conventional video encoders), the XR server 720 and/or device 200 sends a low-latency video stream to the XR device 702. The low-latency video stream may use encoding schemes comprising conventional video streams, e.g. using intra-frames and/or predictive frames (also denoted as intra coded picture and/or predictive coded picture, or briefly I-frames and/or P-frames, respectively). I-frames may be intra-encoded (e.g., self-contained), while P-frames may encode the difference between the previous and the current frame.

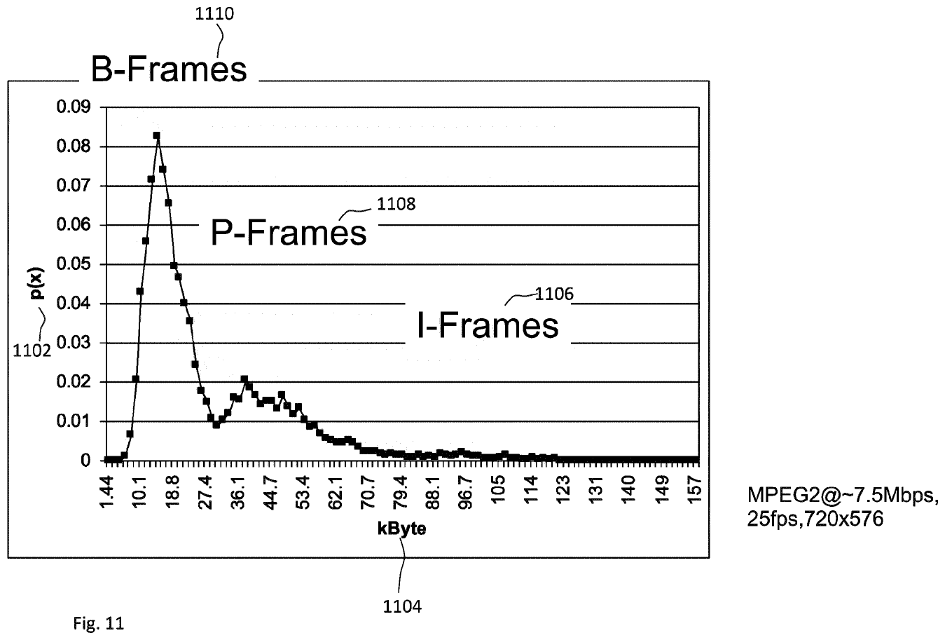

FIG. 11 depicts a (e.g., probability) distribution 1102 of exemplary ADU sizes and/or frame sizes (e.g., in units of kilo Bytes, kB, at reference sign 1104) of different ADU and/or frame types, e.g., according to the MPEG-2 standard of the Moving picture experts group (MPEG). E.g., a resolution may comprise 720×576 pixels, a frame rate may comprise 25 frames per second (25 fps), and/or a data rate may comprise 7.5 Megabits per second (7.5 Mbps). Alternatively or in addition, video frames 1106, 1108, 1110 are schematically illustrated in FIG. 11 as examples of the ADUs.

Bidirectional frames (also denoted as bidirectional coded pictures and/or briefly B-frames) 1110 are conventionally not used in low-latency encoding. The frame sizes can decrease (e.g., as compared to conventional encoding and decoding) for more modern coder-decoders (also briefly denoted as codecs), however, at least one of the following principles may remain: I-frames 1106 are typically very large, and the frame size depends on the image complexity. P-frames 1108 are typically much smaller then I-frames 1106. When there is only little change between two consecutive frames, the frame size of a P-frame 1108 is very small. A P-frame 1108 may have the size of an I-frame 1106 (e.g., only) when the scene completely changes, e.g. at a scene cut. B-frames 1110 are typically even smaller than P-frames 1108 and may follow the same principles as P-frames 1108.

As I-frames 1106 are typically larger than P-frames 1108 and/or B-frames 1110, the I-frames 1106 typically require more transmission time than the P-frames 1108 and/or B-frames 1110. Alternatively or in addition, I-frames 1106 may allow for a lower latency than P-frames 1108 and/or B-frames 1110 due to a lower encoder-decoder complexity.

A key problem to be addressed, e.g., for E2E encrypted ADUs, includes that the conventional QoS handling in CNs (e.g., each comprising a UPF 706) is based on a static or semi-static configuration per flow. The conventional QoS handling does not differentiate the latency at a level of IP packets, and also does not differentiate between (e.g., different latencies of) ADUs. Different IP packets from the same application (e.g., XR) flow may experience different latency over public IP networks, e.g., IP latency jitter. Alternatively or in addition, different IP packets may originate from the same (e.g., XR) frame (and/or the same ADU) destined to, or originating from, the same end terminal (e.g., UE), and/or may be from different (e.g., XR) frames destined to, or originating from, the same end terminal (e.g., UE).

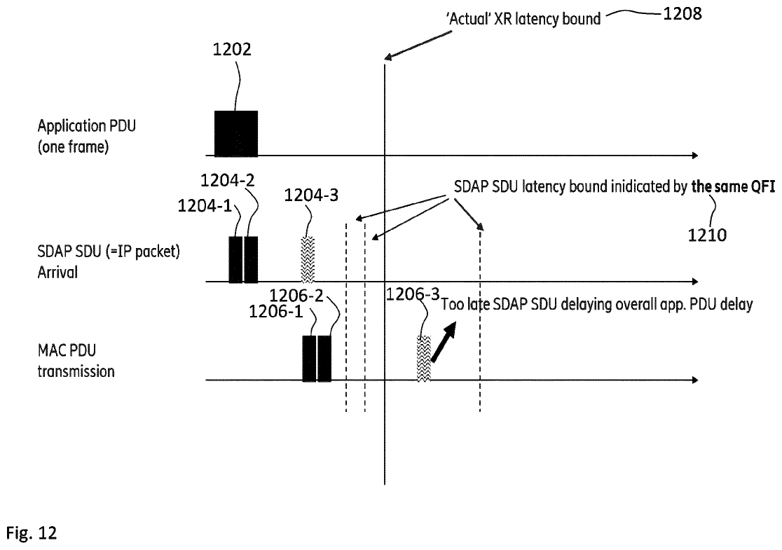

The conventional lack of information to differentiate ADUs (and/or application PDUs) associated to the same (e.g., XR) user (e.g., the user of an end terminal) and IP packets from the same ADU (and/or application PDU) can mislead radio resource allocation. FIG. 12 illustrates the key problem, e.g., without frame indication, and/or, e.g., without knowing the boundary of an ADU (and/or application PDU) in the (e.g., 5G) network, and/or without being aware of a frame-level latency requirement, e.g., as indicated at reference sign 1208 for an ADU (e.g., comprising one frame) 1202.

In FIG. 12, the CN (e.g., comprising UPF 706) may (e.g., erroneously) allocate the same QFI for the first IP packet 1204-1, the second IP packet 1204-2 and the last packet 1204-3 with the same latency requirement, e.g., without any information from the application (e.g., the XR server). Allocating the same QFI with the same latency requirement (e.g., as indicated as dashed lines at reference sign 1210) for all IP packets 1204-1, 1204-2, 1204-3 may cause a (e.g., too) late scheduling of the last IP packet 1204-3, e.g. comprised in a service data adaptation protocol (SDAP) service data unit (SDU), in the RAN (e.g., at network node 704) since the last SDU 1204-3 is marked with the same latency requirement as the first SDU 1204-1 but arrives (e.g., as MAC PDU for transmission at reference sign 1206-3) at the RAN (e.g., at network node 704) later than the first and/or second SDU 1204-1; 1204-2 (e.g., as MAC PDU for transmission at reference sign 1206-1; 1206-2), e.g., due to IP network congestion. The (e.g., too) late arrival at the RAN (e.g., at network node 704), as exemplified at reference sign 1206-3, may exceed the common (e.g., to all IP packets of an ADU) latency required for the corresponding ADU (and/or application PDU) of the (e.g., XR) frame, e.g., as marked by the solid line at reference sign 1208.

Conventionally, it is not ensured that (e.g., 5G) CN, e.g. comprising UPF 706, may access information from applications (e.g., the XR server). More specifically, there is a need for a technique that ensures that the device 100 (e.g. a UPF interface) which first receives the ADU (and/or application PDU, e.g., as one or more IP packets comprising data and/or information units of the ADU) can extract information from the IP packet. Alternatively or in addition, there is a need for a technique that comprises signaling that ADUs (and/or application PDU) deliver extra information to the CN, e.g., as well as how the UPF 100 is configured to receive and/or use (e.g., read, process and/or apply) the extra information.

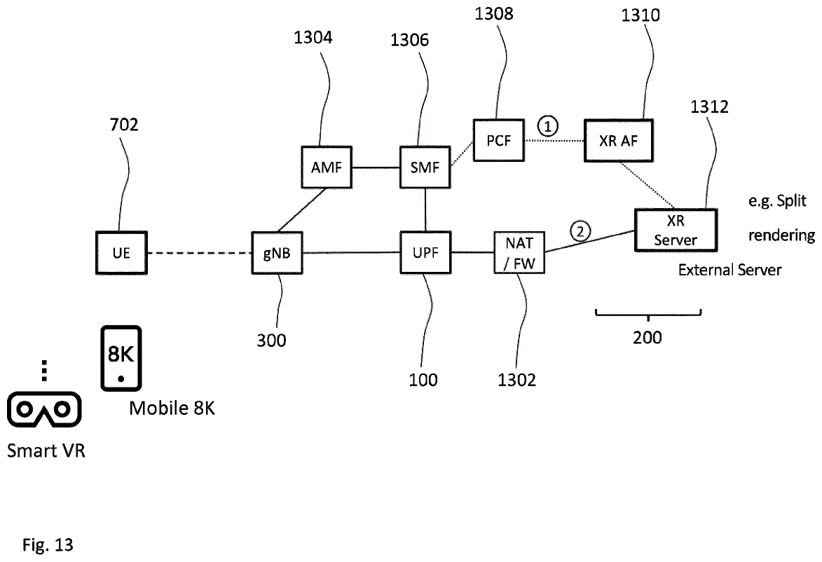

According to at least some embodiments, the (e.g., XR) device 200 (e.g., comprising the application server component 1312 and/or the application function, AF, component 1310) in FIG. 13 notifies (e.g., according to the method step 402) the (e.g., 5G) CN (e.g., the UPF 100 via the policy control function, PCF, 1308, and the session management function, SMF, 1306) that the application information, e.g. as the first information element, is inserted into the traffic (e.g., IP packet) flow and that the UPF 100 should start looking for related information, e.g., first information elements, for specific traffic (e.g., described by conventional packet detection rules). The notification of the application information (which may also be denoted as message indicative of the presence of the first information element according to the method step 402) may indicate an information content of the first information element, e.g., as detailed below.

The CN of FIG. 13 further comprises an access and mobility management function (or briefly: access and mobility function, AMF) 1304. Alternatively or in addition, IP packets are sent from the application server 200 through the NAT/FW 1302 to the UPF 100 in FIG. 13.

The application information (e.g., comprising the first information element according to the step 404 or 508 and/or the message indicative of the presence of the first information element according to the step 402) describes how the device 200 (e.g., comprising an application server and/or XR server) is packaging data and/or information units (e.g., of ADUs which are segmented and/or transmitted in multiple IP packets). E.g., at least the size of an ADU may be signaled (e.g., comprised in the first information element in the method steps 404 and/or 508). Alternatively or in addition, a time to the next ADU and/or an ADU periodicity may be signaled (e.g., comprised in the first information element in the method steps 404 and/or 508). The “time” in case of (e.g., XR) traffic may comprise a time span (e.g., a duration) to the next (e.g., video) frame and/or ADU, e.g., 10 milliseconds (10 ms) in case of 100 frames per second (100 fps) XR content.

According to at least some embodiments, the application server (e.g., the XR server and/or device 200) need not, or may not, disclose any information about the content (e.g., of an ADU) and/or the service (e.g., related to the ADU and/or which is conventionally subject to privacy) to the CN (e.g., comprising the UPF and/or device 100) and/or RAN (e.g., comprising at least one network node and/or device 300).

Beneficially, according to at least some embodiments, the application information (e.g., comprising the first information element and/or the second information element) from the application (e.g., comprising the device 200 and/or an XR server) can ensure that (e.g., 5G) CN (e.g., comprising the UDP and/or device 100) is enabled to deliver relevant information to the RAN (e.g., to at least one network node and/or device 300) which can efficiently prioritize related (e.g., originating from the same ADU and/or consecutive ADUs) IP packets together for resource allocation and scheduling.

The use of the first information element and/or the second information element, as disclosed for a downlink (DL) data flow from the device 100 (e.g., an application server) to (e.g., a client comprised in) the end terminal (e.g., UE) 702 according to the methods 400, 500 and/or 600, may also be introduced and/or applied to an uplink (UL) data flow from the end terminal (e.g., UE) 702 to the device 100 (e.g., the application server).

According to a first class of embodiments, a variety of (e.g., first) information elements may be signaled by the application (e.g., device 200 and/or the XR server) to help the (e.g., 5G) CN (e.g., comprising the UPF and/or device 100) and/or RAN (e.g., comprising at least one network node and/or device 300), e.g., in the steps 404 and/or 508. Any example comprised in the first class of embodiments may be combinable with any other example, any other embodiment, and/or any other class of embodiments disclosed herein.

Examples of information comprised in the (e.g., first) information element comprise an ADU boundary indication, for example video frame boundaries; an ADU start indication, for example a video frame start indication; an ADU start and end indication, and/or an ADU start and size indication; an ADU latency requirement; an ADU latency requirement which may be associated with any application (e.g., XR) retransmission mechanism; and/or a periodicity of ADU generation, alternatively an indication of the duration to the next ADU (e.g., which supports varying periodicities).

Further examples of information comprised in the (e.g., first) information element comprise a first ADU generation time. The ADU generation time may comprise an absolute generation time. Alternatively or in addition, the ADU generation time may comprise a relative generation time, e.g., comprised in an information element in the ADU.

The absolute ADU generation time may assume that the (e.g., NG) RAN (e.g., comprising at least one network node and/or device 300) and the ADU generation entity (e.g., the device 100 and/or XR server) are synchronized to the same (e.g., reference) clock (also denoted as wall clock), so that a timestamp (e.g., comprised in the ADU header and/or in the first information element) may be correctly interpreted by the RAN (e.g., comprising at least one network node and/or device 300).

The relative ADU generation time may use the reception time of a first ADU as reference. The ADU header (e.g., comprising the first information element) may contain information, e.g., an ADU duration and/or a time to a next ADU. The (e.g., NG) RAN (e.g., comprising at least one network node and/or device 300) may determine the ADU generation time by combining the relative time with the reception time of the first ADU.

The ADU header may, e.g., denote the header of an IP packet comprising data and/or information units of the ADU. Alternatively or in addition, the ADU header may comprise a common part of all headers of IP packets comprising data and/or information units of the (e.g., same) ADU.

Still further examples of information comprised in the (e.g., first) information element comprise an information of each ADU size; a (e.g., long-term) statistical information, e.g., mean and variance of an ADU (e.g., video frame) size, and/or (e.g., long-term) statistical information which may be also associated with an encoder configuration, e.g., an average bit rate and/or refresh rate; information about whether an ADU is useful for the receiver (e.g., end terminal 702) even if it is not delivered to the receiver within the latency requirement (e.g., information, whether the ADU should be dropped, and/or discarded, when not fulfilling the latency requirement); and/or information about whether an ADU is useful for the receiver (e.g., end terminal 702), and/or if the network should try to deliver the ADU despite it not being delivered to the receiver (e.g., end terminal 702) within the latency requirement, and/or until when the ADU is useful (e.g., the information comprising a latest delivery time after which the ADU may be discarded and/or dropped).

The QoS requirement of the ADU and/or any (e.g., extended) IP packet comprising data and/or information units of the ADU may comprise the latency requirement and/or a retransmission requirement.

The latency requirement may be obtained by different means. E.g., it may be a fixed requirement that an ADU (e.g., a video frame) has a maximal latency requirement of 20 ms. Depending on how the latency requirement is defined, it may be that the (e.g., 5G) network has 20 ms at most to deliver the ADU, and/or that, since the application delivers the ADU to lower layers, the ADU has 20 ms to reach the destination. The inventive concept does not depend on details of (e.g., conventionally) defining the latency requirement.

Alternatively or in addition, the QoS requirement and/or the latency requirement may relate to time-sensitive networking (TSN).

E.g., independently of the details of defining the latency requirement, the first information element and/or the ADU may indicate if (e.g., may indicate a criterion for determining if) the network, e.g., the device 300, should still deliver the IP packet or not (e.g., in which case, it may drop the IP packets of the ADU) even in the case it does not meet the latency requirement.

According to a second class of embodiments, the information comprised in the first information element be delivered to (e.g., 5G) CN, in particular to the UPF and/or device 100, via different ways. Any example according to the second class of embodiments may be combinable with any other example according to the second class of embodiments, any other embodiment, and/or any other class of embodiments disclosed herein.

Examples are comprise including one or several bits in the header of the IP packet (and/or application PDU) to carry the ADU information; enabling the layer providing E2E encryption to exclude the ADU information from the encryption process, e.g., ADU information may be transferred in clear text; sending a separate signaling (e.g., comprising a first information element) which conveys the (e.g., long-term) statistical information of ADUs out of band, e.g. from the application function (AF, e.g., as component of the XR application server) via a network exposure function (NEF) to the policy control function (PCF); and/or sending a separate signaling (e.g., comprising a first information element) which conveys information about the presence of the ADU information in the data stream (e.g., described by a Service Data Flow Filter information) out of band, e.g., from the AF and/or XR application server, via a NEF to the PCF. The separate signaling may include information which ADU information is present and/or provided (e.g., as message indicative of the presence of the first information element in the step 402).

While the information according to the second class of embodiments is described for a DL data flow from the device 100 (e.g., an application server) to the end terminal 702 according to the methods 400, 500 and/or 600, it may also be included in an UL data flow from the end terminal 702 to the device 100. In particular, also the end terminal 702 may provide (e.g., long-term) statistical information of ADUs out of band and/or signal the presence of a (e.g., first) information element comprised in IP packets of ADUs produced by the end terminal 702.

According to third class of embodiments, the (e.g., 5G) system (briefly referred to as 5GS) and/or the device 100 may expose its capability to support and use (also: handle) ADU information to the device 200 (e.g., the XR server), e.g. from PCF 1308 to the AF 1310. Alternatively or in addition, the device 100 may send a message indicative of its capability of reading 406 the first information element, e.g., to the device 200 (e.g., the XR server). The third class of embodiments may be combinable with any other embodiment, and/or any other class of embodiments disclosed herein.

According to a fourth class of embodiments, the (e.g., ADU) information comprised in the first information element be delivered from (e.g., 5G) CN to the RAN (e.g., comprising the device 300 and/or at least one network node) and/or an interface between at least one network node (e.g., embodying the device 300 and/or associated to the, e.g. NG, RAN) and the CN, e.g., comprising the device 100, in different ways. Any example according to the fourth class of embodiments may be combinable with any other example within the fourth class of embodiments, any other embodiment, and/or any other class of embodiments.

An example comprises informing in a PDU Session management signaling the (e.g., NG) RAN about the presence of the ADU information in extended IP packets, e.g., GPRS tunneling protocol (GTP) packets, (e.g. as extended IP packet headers, in particular GTP extension headers, comprising the second information element) associated with a particular QoS and/or a particular QFI. Alternatively or in addition, the device 100 may send a message indicative of a presence of the second information element in relation to at least one extended IP packet (e.g., a GTP packet) to the device 300.

Further examples comprise, alternatively or in addition, informing in the PDU session management signaling the (e.g., NG) RAN (e.g., comprising the device 300) about the presence of the ADU information in the (e.g., extended) IP packets associated with a particular QoS and/or QFI; informing in the PDU session management signaling the (e.g., NG) RAN (e.g., comprising the device 300) about what components of the ADU information in the extended IP packets (e.g., GTP packets) associated with a particular QoS and/or a particular QFI are carrying (e.g., valid) information; alternatively or in addition, informing in the PDU session management signaling the (e.g., NG) RAN (e.g., comprising the device 300) about what components of the ADU information in the (e.g.,extended) IP packets associated with a particular QoS and/or a particular QFI are carrying (e.g., valid) information; the device 100 (e.g., comprising the UPF) tagging data streams, comprising ADU information (e.g., within the second information element) with a QoS and/or QFI, so that (e.g., NG) RAN (e.g., comprising the device 300) can easily detect the data stream; the device 100 (e.g., comprising the UPF) detecting IP packets comprising ADU information (e.g., within the first information element) based on a pre-configured packet filter and/or a packet filter configured by the CN, e.g., by SMF 1306; and/or the device 100 (e.g., comprising the UPF) extracting ADU information (e.g., within the first information element) from DL IP packets received on an N6 interface and including and/or copying that ADU information (e.g., comprised in the second information element) into an general packet radio service (GPRS) Tunneling Protocol User plane (GTP-U) extension header of the DL GTP-U packets.

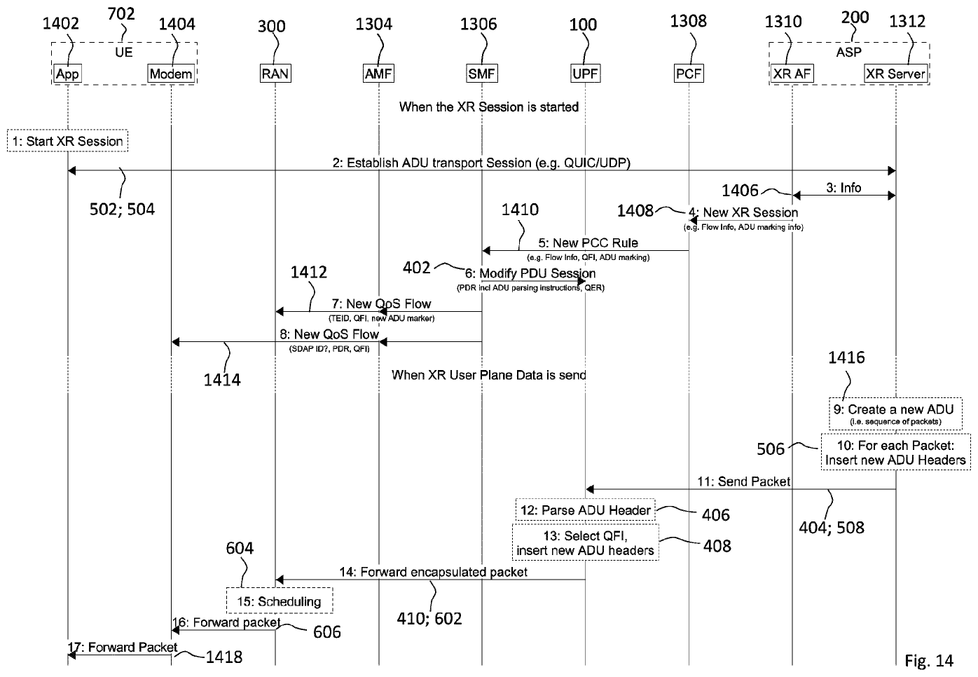

FIG. 14 shows an exemplary signaling diagram or flowchart resulting from embodiments of the methods 400, 500 and 600 transmitting one or more ADUs in the DL from a device 200 to an end terminal 702 comprising a modem 1404 and an application 1402 associated to the application server 1312 within the device 200.

The example is provided for concreteness for XR as application, but not limited thereto.

A user of the end terminal 702 may start the XR session, e.g. by mounting a head-mounted display (HMD) and launching a game, and establish one or more transport session with the device 200 according to the steps 502 and 504. Transport may herein refer to TCP/IP, which may be similar to a Layer 4 in an open systems interconnection (OSI) model.

At reference sign 1406, the XR server 1312 (e.g. in an edge cloud) may interact with an XR AF 1310 within the device 200. The XR AF 1310 may comprise a control entity, which is controlling the XR application service 1312 within the device 200.

An edge cloud architecture may be used to decentralize (e.g., processing) power to the edges (e.g. comprising clients and/or devices) of the telecommunications system. Conventionally, the computing power of servers may be used to perform tasks such as data minimization, or to create advanced distributed systems. Within the cloud model, such ‘intelligent’ tasks may be performed by servers so they can be transferred to other devices with less, or almost no, computing power.

At reference sign 1408, the XR AF 1310 may act as AF towards the (e.g., 5G) telecommunications system (e.g., the PCF 1308). The XR AF 1310 may activate a related policy, providing a flow information element (e.g., for application traffic detection) on the ADU characteristics, marking and some desired QoS and/or QFI information (e.g., comprised within the first information element).

At reference sign 1410, the PCF 1308 may create a policy control and charging (PCC) rule with related ADU reading (also denoted as “parsing”) instructions for application traffic detection and passes the new PCC rule to the SMF 1306. At reference sign 402, the SMF 1306 may derive from the PCC rule a PDU session modification command (e.g., signaled over an N4 interface), which comprises information for a packet detection rule (PDR, e.g., based on the flow information) and further ADU reading (and/or ADU parsing) instructions. The further ADU parsing information comprises packet inspection instructions (e.g. where to find an ADU size, and/or any information comprised in the first information element), and/or QoS enforcement rules (QER).

In the (e.g., 5G) CN, the N4 interface may be the bridge between the control plane and the user plane.

Alternatively or in addition the step 402 of the method 400 may comprise the signaling from the device 200, in particular XR AF 1310, via the PCT 1308 (at reference sign 1408) and the SMF 1306 (at reference sign 1410) to the UPF 100.

At reference sign 1412, the SMF 1306 may provide related information via the AMF 1304 to the RAN 300. The information may include the QoS and/or QFI, and/or packet treatment policies, e.g. described by a QoS profile and/or a QFI profile, and/or an indication that additional ADU (e.g., header) information is included in extended IP packets (e.g., GTP packets), and which components carry (e.g., valid) information. The step 1412 may also be denoted as sending a message indicative of a presence of the second information element in relation to one or more extended IP packets. Alternatively or in addition, the message may comprise a tunnel endpoint identifier (TEID).

At reference sign 1414, the SMF 1306 may further send the related information via the AMF 1304 (and/or NAS) to the modem 1404 of the end terminal 702. The information may mostly comprise information around UL application traffic detection and/or policy treatment.

The any one of the steps 502, 504, 1406, 1408, 1410, 402, 1412 and 1414 may be executed (e.g., only once) at the application (e.g., XR) session establishment.

When the XR user plane is used with the ADU marking (e.g., comprising the first information element and/or the second information element) according to an embodiment of the technique, at least one of the following steps may be executed.

At reference sign 1416, the XR server 1312 (e.g., comprised in the device 200) may create a new ADU with a predetermined (e.g., fixed or varying) periodicity. An ADU comprise a video frame, e.g. for view-point dependent (VPD) rendering. Typically, an ADU is split and carried by multiple IP Packets. The inventive concept provide different ways to mark the IP packets of one ADU and to convey information about the ADU (e.g., within the first information element).

A simple implementation of the marking comprises a start and/or size marking. The IP Packet, comprising the start of an ADU, may also comprise the size of an ADU (e.g., the presence of the ADU size may determine also the start of an ADU). All IP packets, which belong to the same ADU, may be identified, e.g., by carrying the same ADU sequence number. Further implementations of the marking may comprise variants, e.g., as disclosed in the context of the first class of embodiments.

At reference sign 506, the XR server 1312 may create an IP packet. Depending on the type of the IP packet (e.g., at an ADU start or within the ADU body), the XR server 1312 may insert the ADU header information (e.g., the first information element). The ADU header (e.g., the first information element) is not encrypted.

In the step 508, the XR server 1312 sends the IP packet, which is received in the step 404 at the UPF 100.

At reference sign 406, e.g., based on the PDR, the UPF 100 may perform application traffic detection and determine that ADU parsing and/or ADU processing should be applied. E.g., in case, that a Service Data Flow Filter for the XR traffic matches, the UPF 100 may parse the IP packet headers and/or ADU headers, e.g., by reading 406 the first information element.

At reference sign 408, the UPF 100 may selects the correct QFI, encapsulates the IP packet, e.g., as GTP Payload, and add the ADU information as second information element of an extended IP packet and/or as GTP header information.

At reference signs 410 and/or 602, the UPF 100 may forward the encapsulated (e.g., extended) IP packet, e.g., as GTP packet, to the RAN 300 (e.g., to a network node, in particular a gNB).

At reference sign 604, the RAN (e.g., comprising a network node, in particular a gNB, and/or device 300) may detect, based on the QFI, that the extended IP packet, e.g., the GTP packet, comprises a second information element and/or an additional ADU header. Based on the second information element and/or the additional ADU information, the RAN (e.g., gNB) 300 may take the relevant scheduling, forwarding, and IP packet dropping decisions.

When the RAN (e.g., gNB) 300 schedules the IP packet and/or all IP packets from the ADU, at reference sign 606, the RAN (e.g., gNB) 300 forwards the IP packet over the radio interface.

At reference sign 1418, the modem 1404 of the end terminal 702 may forward the IP packet towards the application 1402.

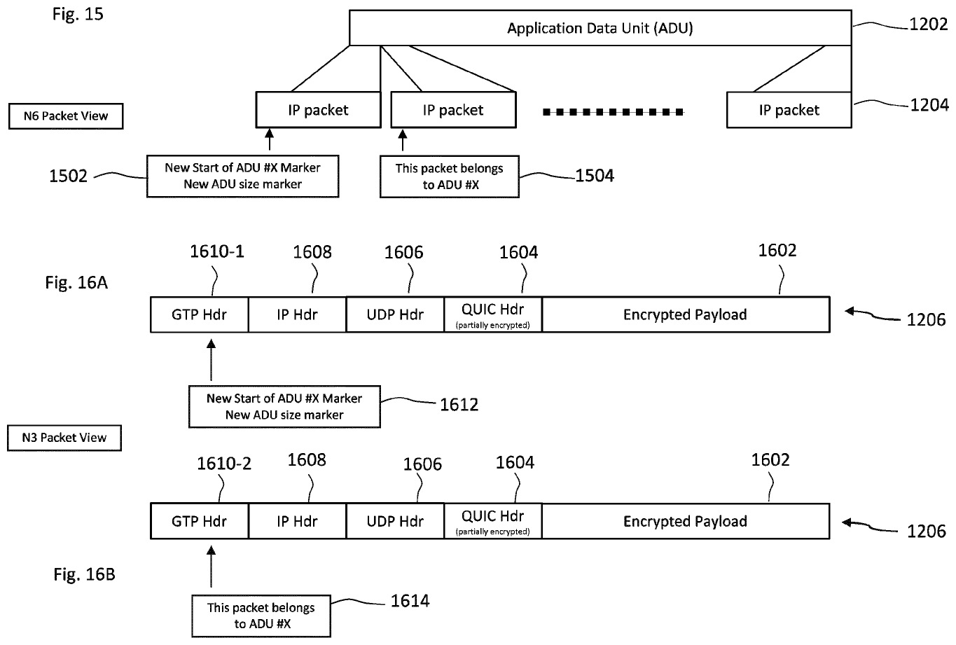

Variants of the above embodiments or alternative implementations to include the ADU information (e.g., the first information element and/or the second information element), optionally as clear text, into IP packets are disclosed with reference to any one of FIGS. 15 to 18.

FIG. 15 illustrates the splitting of an ADU 1202 into multiple IP packets 1204. The application may determine the ADU size, e.g., on a need basis. For example, when using video frames as ADUs 1202, an I-frame may typically be of much larger size than a P- or B-frame.

In the example of FIG. 15, the first IP packet of an ADU 1202 may comprise an indication of an ADU start and also an indication of an ADU size (e.g., comprised within the first information element), as indicated at reference sign 1502. All IP packets belonging to the same ADU may be marked accordingly (e.g., within the first information element), e.g. using an ADU sequence number as indicated at reference sign 1504. The splitting of ADUs 1202 as exemplified in FIG. 15 may be denoted as “N6 view”, e.g., for transmitting the IP packets 1204 over the N6 interface from the device 200 to the device 100.

FIGS. 16A and 16B illustrate examples of extended IP packets 1206 for transmission from the device 100 to the device 300, e.g., over an N3 interface. The extended IP packet 1206 in FIG. 16A may comprise the first IP packet 1204 of the ADU 1202, as indicated by the ADU start marker at reference sign 1612. The extended IP packet 1206 of FIG. 16B may comprise an IP packet 1204 from the body of the ADU 1202, as indicated by, e.g., including an ADU sequence number, at reference sign 1614. Any of the extended IP packets 1206 may comprise encrypted payload 1602, a QUIC header 1604 (which may be, e.g., partially encrypted), an UDP header 1606, an IP header 1608 and a GTP header 1610-1 for the first IP packet 1206 and a GTP header 1610-2 for the IP packets 1206 from the ADU body.

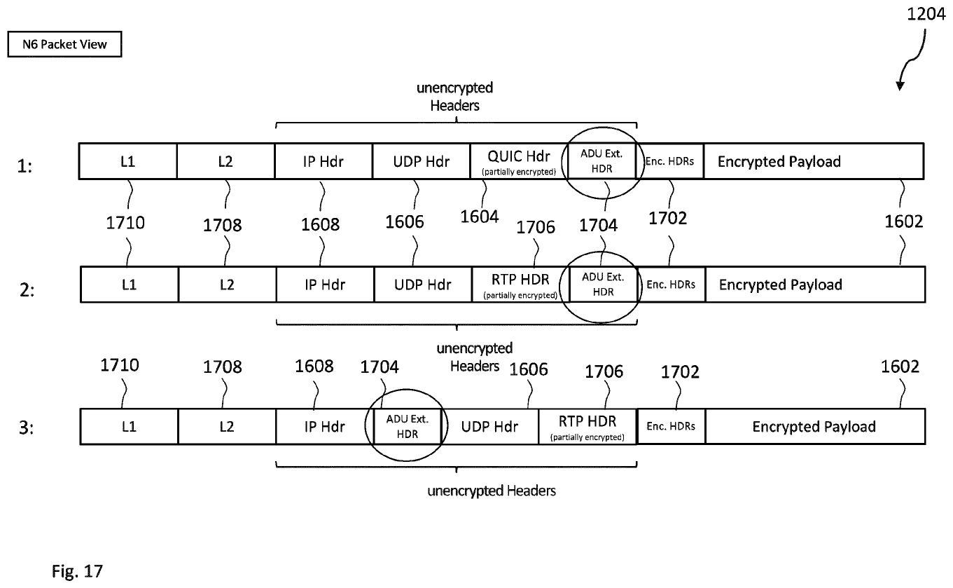

Within the protocol stack, the first information element (and/or the ADU headers) may be positioned at different layers, as exemplified in FIG. 17.

Option 1 in FIG. 17 indicates that the first information element and/or the ADU information is conveyed using the QUIC headers 1604 comprising the extension at reference sign 1704.

Option 2 in FIG. 17 indicates that the first information element and/or the ADU information is conveyed as RTP extension headers 1706 comprising the extension at reference sign 1704.

Option 3 in FIG. 17 indicates that the first information element and/or the ADU information is conveyed as IP extension headers 1608 comprising the extension at reference sign 1704. The benefit of option 3 is that the ADU information may be used together with any higher layer protocol, e.g., QUIC and/or RTP.

Lower layer headers are provided at reference signs 1708 for Layer 2 and 1710 for Layer 3.

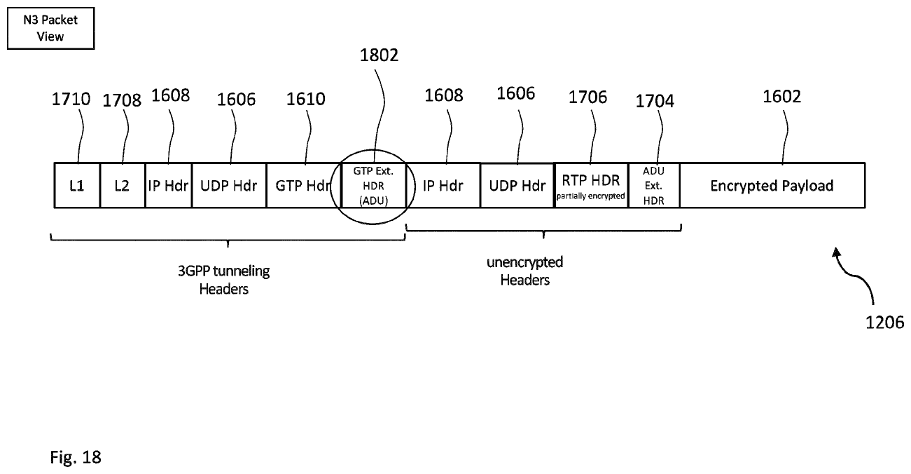

FIG. 18 illustrates an example of how the UPF 100 converts the information of the first information element into the second information element 1802 comprised in the GTP headers 1610, so that the RAN 300 can easily find the information comprised in the second information element 1802. In the example of FIG. 18, the ADU information is inserted as GTP extension headers 1802 into the PDU session.

The extended IP packet 1206 of FIG. 18 may be sent over the N3 interface from the UPF 100 to the RAN 300.

The technique may be applied to uplink (UL) and/or downlink (DL).

The end terminal 702 may be a radio device, and the device 300 may be a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

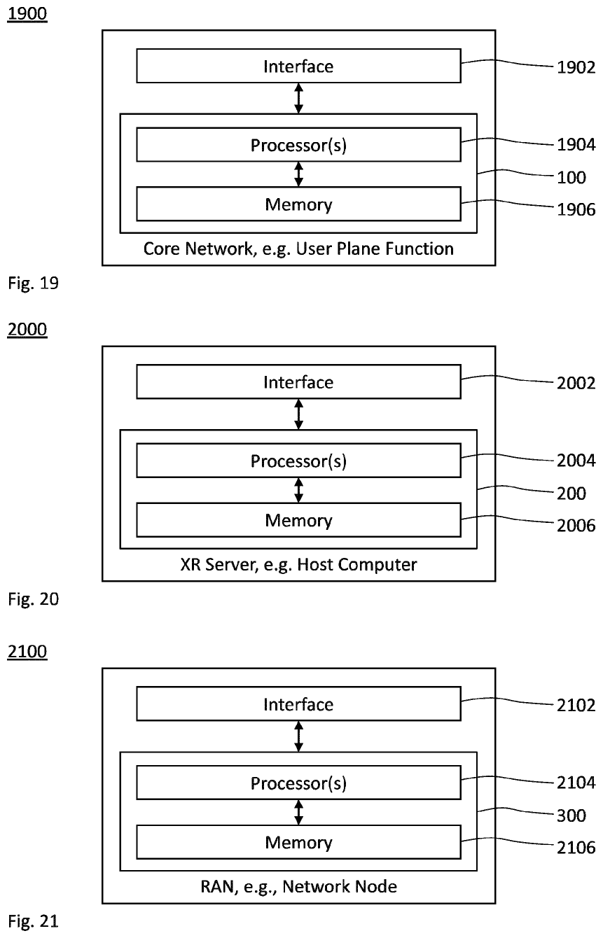

FIG. 19 shows a schematic block diagram for an embodiment of the device 100. The device 100 comprises processing circuitry, e.g., one or more processors 1904 for performing the method 400 and memory 1906 coupled to the processors 1904. For example, the memory 1906 may be encoded with instructions that implement at least one of the modules 104, 106, 108 and 110.

The one or more processors 1904 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1906, gateway or UPF functionality. For example, the one or more processors 1904 may execute instructions stored in the memory 1906. Such functionality may include providing various features and steps discussed herein, including any of the benefits disclosed herein. The expression “the device being operative to perform an action” may denote the device 100 being configured to perform the action.

As schematically illustrated in FIG. 19, the device 100 may be embodied by a CN, in particular UPF 1900, e.g., functioning as a gateway between an application server, in particular an XR server, and a UE. The CN, in particular UPF 1900, comprises a radio interface 1902 coupled to the device 100 for radio communication with one or more base stations, and/or one or more application servers, in particular XR servers.

FIG. 20 shows a schematic block diagram for an embodiment of the device 200. The device 200 comprises processing circuitry, e.g., one or more processors 2004 for performing the method 500 and memory 2006 coupled to the processors 2004. For example, the memory 2006 may be encoded with instructions that implement at least one of the modules 206 and 208.

The one or more processors 2004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 2006, functionality of an application server or data server. For example, the one or more processors 2004 may execute instructions stored in the memory 2006. Such functionality may include providing various features and steps discussed herein, including any of the benefits disclosed herein. The expression “the device being operative to perform an action” may denote the device 200 being configured to perform the action.

As schematically illustrated in FIG. 20, the device 200 may be embodied by an application server, in particular XR server 2000, e.g., functioning as a transmitting station of ADUs. The application server 2000 comprises a radio interface 2002 coupled to the device 200 for radio communication with the CN, in particular to the UPF.

FIG. 21 shows a schematic block diagram for an embodiment of the device 300. The device 300 comprises processing circuitry, e.g., one or more processors 2104 for performing the method 600 and memory 2106 coupled to the processors 2104. For example, the memory 2106 may be encoded with instructions that implement at least one of the modules 302, 304 and 306.

The one or more processors 2104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 300, such as the memory 2106, base station functionality. For example, the one or more processors 2104 may execute instructions stored in the memory 2106. Such functionality may include providing various features and steps discussed herein, including any of the benefits disclosed herein. The expression “the device being operative to perform an action” may denote the device 210 being configured to perform the action.

As schematically illustrated in FIG. 21, the device 300 may be embodied by a base station 2100. The base station 2100 comprises a radio interface 2102 coupled to the device 300 for radio communication with the CN and/or one or more UEs.

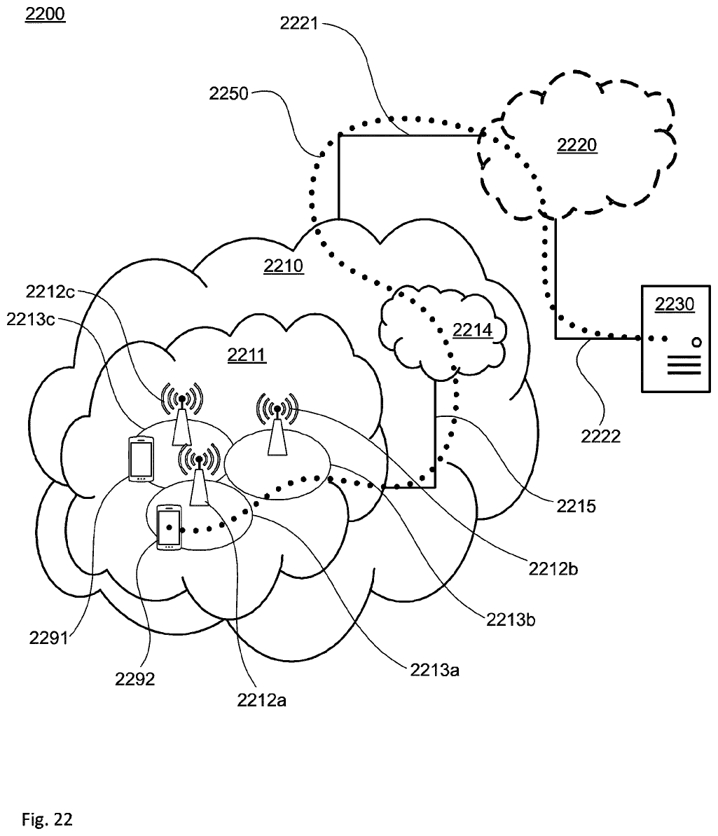

With reference to FIG. 22, in accordance with an embodiment, a communication system 2200 includes a telecommunication network 2210, such as a 3GPP-type cellular network, which comprises an access network 2211, such as a radio access network, and a core network 2214. The access network 2211 comprises a plurality of base stations 2212a, 2212b, 2212c, such as NBs, eNBs, gNBs or other types of wireless access points, each defining a corresponding coverage area 2213a, 2213b, 2213c. Each base station 2212a, 2212b, 2212c is connectable to the core network 2214 over a wired or wireless connection 2215. A first user equipment (UE) 2291 located in coverage area 2213c is configured to wirelessly connect to, or be paged by, the corresponding base station 2212c. A second UE 2292 in coverage area 2213a is wirelessly connectable to the corresponding base station 2212a. While a plurality of UEs 2291, 2292 are illustrated in this example, the disclosed embodiments are equally applicable to a situation where a sole UE is in the coverage area or where a sole UE is connecting to the corresponding base station 2212.

The core network 2214 may comprise or may embody the device 100. Alternatively or in addition, a host computer 2230 may embody the device 200. Further alternatively or in addition, any of the base stations 2212 may embody the device 300.

The telecommunication network 2210 is itself connected to the host computer 2230, which may be embodied in the hardware and/or software of a standalone server, a cloud-implemented server, a distributed server or as processing resources in a server farm. The host computer 2230 may be under the ownership or control of a service provider, or may be operated by the service provider or on behalf of the service provider. The connections 2221, 2222 between the telecommunication network 2210 and the host computer 2230 may extend directly from the core network 2214 to the host computer 2230 or may go via an optional intermediate network 2220. The intermediate network 2220 may be one of, or a combination of more than one of, a public, private or hosted network; the intermediate network 2220, if any, may be a backbone network or the Internet; in particular, the intermediate network 2220 may comprise two or more sub-networks (not shown).

The communication system 2200 of FIG. 22 as a whole enables connectivity between one of the connected UEs 2291, 2292 and the host computer 2230. The connectivity may be described as an over-the-top (OTT) connection 2250. The host computer 2230 and the connected UEs 2291, 2292 are configured to communicate data and/or signaling via the OTT connection 2250, using the access network 2211, the core network 2214, any intermediate network 2220 and possible further infrastructure (not shown) as intermediaries. The OTT connection 2250 may be transparent in the sense that the participating communication devices through which the OTT connection 2250 passes are unaware of routing of uplink and downlink communications. For example, a base station 2212 need not be informed about the past routing of an incoming downlink communication with data originating from a host computer 2230 to be forwarded (e.g., handed over) to a connected UE 2291. Similarly, the base station 2212 need not be aware of the future routing of an outgoing uplink communication originating from the UE 2291 towards the host computer 2230.

By virtue of the method 400 being performed by the CN 2214, the method 500 being performed by the host computer 2230 and/or the method 600 being performed by any one of the base stations 2212, the performance or range of the OTT connection 2250 can be improved, e.g., in terms of increased throughput and/or reduced latency. More specifically, the host computer 2230 may indicate to the RAN 2211 (e.g., on a transport layer and/or an application layer) the QoS of the traffic.

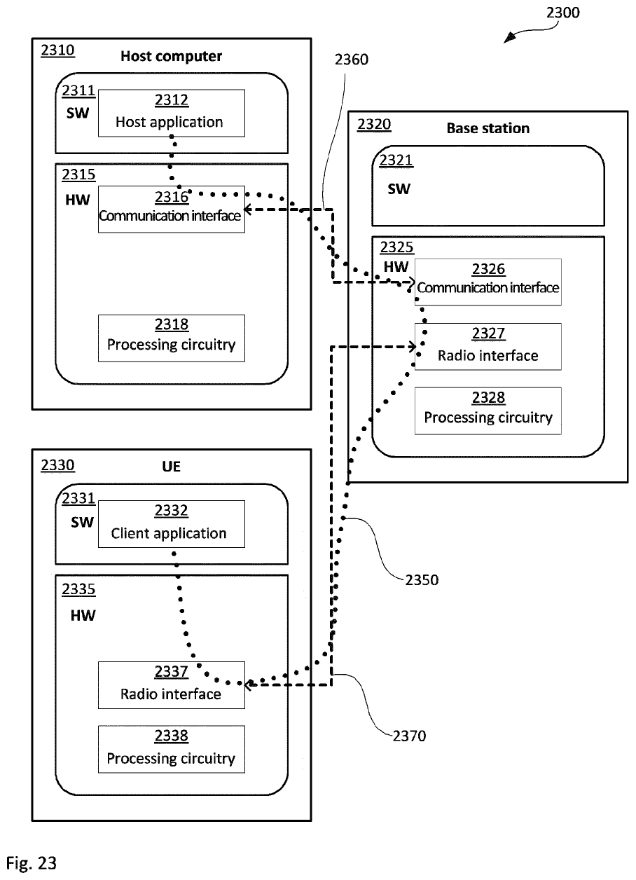

Example implementations, in accordance with an embodiment of the UE, base station and host computer discussed in the preceding paragraphs, will now be described with reference to FIG. 23. In a communication system 2300, a host computer 2310 (e.g., embodying the device 200) comprises hardware 2315 including a communication interface 2316 configured to set up and maintain a wired or wireless connection with an interface of a different communication device of the communication system 2300. The host computer 2310 further comprises processing circuitry 2318, which may have storage and/or processing capabilities. In particular, the processing circuitry 2318 may comprise one or more programmable processors, application-specific integrated circuits, field programmable gate arrays or combinations of these (not shown) adapted to execute instructions. The host computer 2310 further comprises software 2311, which is stored in or accessible by the host computer 2310 and executable by the processing circuitry 2318. The software 2311 includes a host application 2312. The host application 2312 may be operable to provide a service to a remote user, such as a UE 2330 connecting via an OTT connection 2350 terminating at the UE 2330 and the host computer 2310. In providing the service to the remote user, the host application 2312 may provide user data, which is transmitted using the OTT connection 2350. The user data may depend on the location of the UE 2330. The user data may comprise auxiliary information or precision advertisements (also: ads) delivered to the UE 2330. The location may be reported by the UE 2330 to the host computer, e.g., using the OTT connection 2350, and/or by the base station 2320 (e.g., embodying the device 300), e.g., using a connection 2360.

The communication system 2300 further includes a base station 2320 provided in a telecommunication system and comprising hardware 2325 enabling it to communicate with the host computer 2310 and with the UE 2330. The hardware 2325 may include a communication interface 2326 for setting up and maintaining a wired or wireless connection with an interface of a different communication device of the communication system 2300, as well as a radio interface 2327 for setting up and maintaining at least a wireless connection 2370 with a UE 2330 located in a coverage area (not shown in FIG. 23) served by the base station 2320. The communication interface 2326 may be configured to facilitate a connection 2360 to the host computer 2310. The connection 2360 may be direct, or it may pass through a core network (not shown in FIG. 23) of the telecommunication system and/or through one or more intermediate networks outside the telecommunication system. In the embodiment shown, the hardware 2325 of the base station 2320 further includes processing circuitry 2328, which may comprise one or more programmable processors, application-specific integrated circuits, field programmable gate arrays or combinations of these (not shown) adapted to execute instructions. The base station 2320 further has software 2321 stored internally or accessible via an external connection.

The communication system 2300 further includes the UE 2330 already referred to. Its hardware 2335 may include a radio interface 2337 configured to set up and maintain a wireless connection 2370 with a base station serving a coverage area in which the UE 2330 is currently located. The hardware 2335 of the UE 2330 further includes processing circuitry 2338, which may comprise one or more programmable processors, application-specific integrated circuits, field programmable gate arrays or combinations of these (not shown) adapted to execute instructions. The UE 2330 further comprises software 2331, which is stored in or accessible by the UE 2330 and executable by the processing circuitry 2338. The software 2331 includes a client application 2332. The client application 2332 may be operable to provide a service to a human or non-human user via the UE 2330, with the support of the host computer 2310. In the host computer 2310, an executing host application 2312 may communicate with the executing client application 2332 via the OTT connection 2350 terminating at the UE 2330 and the host computer 2310. In providing the service to the user, the client application 2332 may receive request data from the host application 2312 and provide user data in response to the request data. The OTT connection 2350 may transfer both the request data and the user data. The client application 2332 may interact with the user to generate the user data that it provides.

It is noted that the host computer 2310, base station 2320 and UE 2330 illustrated in FIG. 23 may be identical to the host computer 2230, one of the base stations 2212a, 2212b, 2212c and one of the UEs 2291, 2292 of FIG. 22, respectively. This is to say, the inner workings of these entities may be as shown in FIG. 23, and, independently, the surrounding network topology may be that of FIG. 22.

In FIG. 23, the OTT connection 2350 has been drawn abstractly to illustrate the communication between the host computer 2310 and the UE 2330 via the base station 2320, without explicit reference to any intermediary devices and the precise routing of messages via these devices. Network infrastructure may determine the routing, which it may be configured to hide from the UE 2330 or from the service provider operating the host computer 2310, or both. While the OTT connection 2350 is active, the network infrastructure may further take decisions by which it dynamically changes the routing (e.g., on the basis of load balancing consideration or reconfiguration of the network).

The wireless connection 2370 between the UE 2330 and the base station 2320 is in accordance with the teachings of the embodiments described throughout this disclosure. One or more of the various embodiments improve the performance of OTT services provided to the UE 2330 using the OTT connection 2350, in which the wireless connection 2370 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 2350 between the host computer 2310 and UE 2330, in response to variations in the measurement results. The measurement procedure and/or the network functionality for reconfiguring the OTT connection 2350 may be implemented in the software 2311 of the host computer 2310 or in the software 2331 of the UE 2330, or both. In embodiments, sensors (not shown) may be deployed in or in association with communication devices through which the OTT connection 2350 passes; the sensors may participate in the measurement procedure by supplying values of the monitored quantities exemplified above, or supplying values of other physical quantities from which software 2311, 2331 may compute or estimate the monitored quantities. The reconfiguring of the OTT connection 2350 may include message format, retransmission settings, preferred routing etc.; the reconfiguring need not affect the base station 2320, and it may be unknown or imperceptible to the base station 2320. Such procedures and functionalities may be known and practiced in the art. In certain embodiments, measurements may involve proprietary UE signaling facilitating the host computer's 2310 measurements of throughput, propagation times, latency and the like. The measurements may be implemented in that the software 2311, 2331 causes messages to be transmitted, in particular empty or “dummy” messages, using the OTT connection 2350 while it monitors propagation times, errors etc.

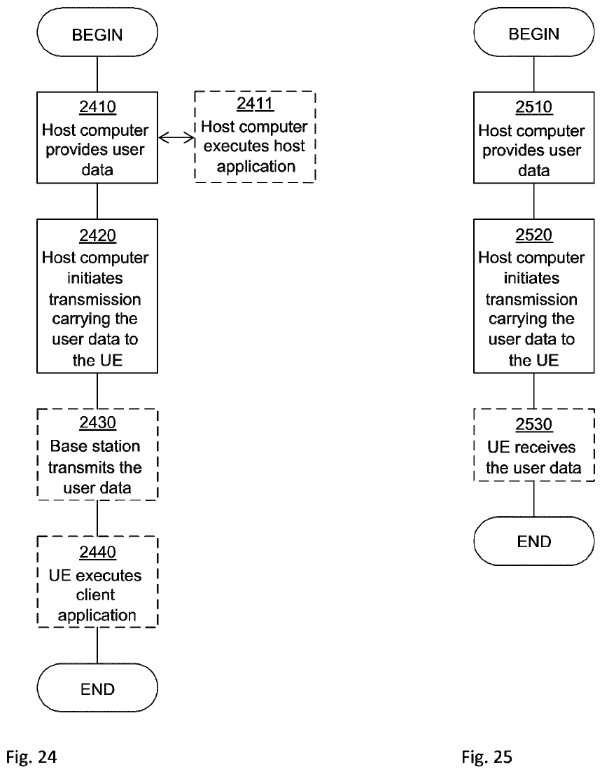

FIG. 24 is a flowchart illustrating a method implemented in a communication system, in accordance with one embodiment. The communication system includes a host computer (e.g., embodying the device 200), a base station (e.g., embodying the device 300) and a UE which may be those described with reference to FIGS. 22 and 23. For simplicity of the present disclosure, only drawing references to FIG. 24 will be included in this paragraph. In a first step 2410 of the method, the host computer provides user data. In an optional substep 2411 of the first step 2410, the host computer provides the user data by executing a host application. In a second step 2420, the host computer initiates a transmission carrying the user data to the UE. In an optional third step 2430, the base station transmits to the UE the user data which was carried in the transmission that the host computer initiated, in accordance with the teachings of the embodiments described throughout this disclosure. In an optional fourth step 2440, the UE executes a client application associated with the host application executed by the host computer.

FIG. 25 is a flowchart illustrating a method implemented in a communication system, in accordance with one embodiment. The communication system includes a host computer (e.g., embodying the device 200), a base station (e.g., embodying the device 300) and a UE which may be those described with reference to FIGS. 22 and 23. For simplicity of the present disclosure, only drawing references to FIG. 25 will be included in this paragraph. In a first step 2510 of the method, the host computer provides user data. In an optional substep (not shown) the host computer provides the user data by executing a host application. In a second step 2520, the host computer initiates a transmission carrying the user data to the UE. The transmission may pass via the base station, in accordance with the teachings of the embodiments described throughout this disclosure. In an optional third step 2530, the UE receives the user data carried in the transmission.

As has become apparent from above description, at least some embodiments of the technique allow for an improved signaling and methods comprising that an e.g., XR) application PDU provides useful information (e.g., application information) to core interface, e.g. UPF, which (e.g., at the end) the CN uses for helping the RAN to optimize radio resource allocation. Furthermore, means to provide the information from the (e.g., XR) application server to a (e.g., 5G) CN that is used to configure the UPF so that the UPF understands and utilizes the information when receiving IP packets that constitute (e.g., XR) frames and/or ADUs are provided.

The XR application server may notify the (e.g., 5G) telecommunications system, that the information (e.g., application information) is inserted into the traffic flow and that the UPF should start looking for related information for specific traffic (e.g., described by regular packet detection rules).

According to at least some embodiments, the application need not disclose any information about the content or the service (e.g., which is typically subject to privacy) of the ADU.

Beneficially, the information (e.g., the application information) from the application can ensure that the (e.g., 5G) CN delivers relevant information to the RAN, in particular without encryption, which can efficiently prioritize related IP packets together for resource allocation and scheduling.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of forwarding an application data unit (ADU) within a telecommunications system comprising a radio access network (RAN) for transmission to an end terminal through the RAN, wherein the transmission of the ADU to the end terminal is subject to a quality of service (QoS) requirement, the method comprising or initiating the steps of:
receiving at least one internet protocol (IP) packet comprising at least one information unit of the ADU, wherein the at least one IP packet further comprises a first information element indicative of a packaging of information units of the ADU into IP packets;
reading the first information element of the received at least one IP packet;
generating at least one extended IP packet comprising a second information element indicative of the QoS requirement of the at least one extended IP packet based on the first information element, wherein the at least one extended IP packet further comprises the received at least one IP packet; and
forwarding the at least one extended IP packet to the RAN.

2. The method of claim 1, wherein the first information element is comprised in a bit field comprising one or more bits of a header of the received at least one IP packet.

3. The method of claim 1, wherein at least one information unit and/or a payload of the received at least one IP packet is encrypted.

4. The method of claim 1, wherein the first information element is received without encryption and/or wherein the first information element is received in clear text.

5. The method of claim 1, further comprising the step of:
receiving a message indicative of a presence of the first information element in relation to the at least one IP packet.

6. The method of claim 5, wherein the received message is indicative of a location of the first information element within the received at least one IP packet.

7. The method of claim 1, wherein the packaging of the information units of the ADU into IP packets comprises at least one of:
a size of the ADU;
an indication of a boundary of the ADU;
a start and/or end of the ADU;
a number of IP packets comprising information units of the ADU;
a time of generating and/or sending the ADU at an application layer of an E2E protocol stack, optionally wherein the E2E protocol stack comprises an E2E encryption protocol stack;
a latency requirement of the ADU;
a retransmission regulation associated to the ADU; and
a periodicity of generating ADUs.

8. The method of claim 1, wherein the packaging of the information units of the ADU is indicative of statistical information comprising at least one of:
a mean size of ADUs generated and/or sent over a predetermined ADU generation and/or sending time span;
a variance of a size of ADUs generated and/or sent over the predetermined ADU generation and/or sending time span;
an average bit rate of an encoder; and
a refresh rate of the encoder.

9. The method of claim 8, wherein the statistical information is received out of band, optionally wherein the statistical information is received through at least one of a network exposure function, NEF, and a policy control function, PCF.

10. The method of claim 1, wherein the packaging of the information units of the ADU is indicative of a provision of discarding the at least one IP packet and/or any further IP packet associated with the ADU if the at least one IP packet and/or any one of the further IP packets is not transmitted to the end terminal within a predetermined latency tolerance time span according to the QoS requirement.

11. The method of claim 1, wherein the method further comprises a step of:
receiving a feedback indicative of a reception of the at least one IP packet and/or the ADU by the end terminal.

12. The method of claim 1, wherein the method further comprises a step of:
sending a message indicative of a capability of reading the first information element.

13. The method of claim 1, wherein the first information element is indicative of a sequence number of the ADU.

14. The method of claim 1, wherein the QoS requirement comprises at least one QoS flow identifier, QFI.

15. The method of claim 1, further comprising the step of:
sending a message indicative of a presence of the second information element in relation to the at least one extended IP packet.

16. The method of claim 1, wherein generating the at least one extended IP packet comprises encapsulating the received at least one IP packet.

17. The method of claim 1, wherein the at least one extended IP packet comprises at least one general packet radio service Tunneling Protocol, GTP, packet.

18. The method of claim 1, wherein the method is performed by a core network, CN, of the telecommunications network, optionally wherein the method is performed by a user plane function, UPF, of the CN.

19. A method of sending an application data unit (ADU) to a core network (CN) of a telecommunications system comprising a radio access network, (RAN) for transmission to an end terminal through the RAN, wherein the transmission of the ADU to the end terminal is subject to a quality of service, (QoS) requirement, the method comprising or initiating the steps of:
generating at least one internet protocol (IP) packet comprising at least one information unit of the ADU, wherein the at least one IP packet further comprises a first information element indicative of a packaging of information units of the ADU into IP packets; and
sending the generated at least one IP packet to the CN.

20. The method of claim 19, further comprising the steps of:
receiving a request for a session establishment from the end terminal; and
establishing at least one transport session to the end terminal responsive to the received request.

21-22. (canceled)

23. A method of transmitting an application data unit (ADU) via a radio access network (RAN) of a telecommunications system to an end terminal, wherein the transmitting of the ADU to the end terminal is subject to a quality of service (QoS) requirement, the method comprising or initiating the steps of:
receiving at least one extended internet protocol (IP) packet, wherein the at least one extended IP packet comprises a second information element indicative of the QoS requirement of the at least one extended IP packet based on a first information element comprised in at least one IP packet, wherein the at least one IP packet is comprised in the at least one extended IP packet and wherein the at least one IP packet comprises at least one information unit of the ADU and the first information element is indicative of a packaging of information units of the ADU into IP packets;
scheduling a transmission opportunity for the at least one IP packet depending on the QoS requirement indicated in the second information element, wherein the transmission opportunity comprises at least one of a time resource and/or a frequency resource of the RAN; and
selectively transmitting the at least one IP packet to the end terminal based on the scheduling.

24-32. (canceled)

33. A device for forwarding an application data unit (ADU) within a telecommunications system comprising a radio access network (RAN) for transmission to an end terminal through the RAN, wherein the transmission of the ADU to the end terminal is subject to a quality of servicer (QoS) requirement, the device comprising memory operable to store instructions and processing circuitry operable to execute the instructions, whereby the device is operative to:
receive at least one internet protocol (IP) packet comprising at least one information unit of the ADU, wherein the at least one IP packet further comprises a first information element indicative of a packaging of information units of the ADU into IP packets;
read the first information element of the received at least one IP packet;
generate at least one extended IP packet comprising a second information element indicative of the QoS requirement of the at least one extended IP packet based on the first information element, wherein the at least one extended IP packet further comprises the received at least one IP packet; and
forward the at least one extended IP packet to the RAN.

34-36. (canceled)

37. A device for transmitting an application data unit (ADU) via a radio access network (RAN) of a telecommunications system to an end terminal, wherein the transmitting of the ADU to the end terminal is subject to a quality of service (QoS) requirement, the device comprising memory operable to store instructions and processing circuitry operable to execute the instructions, whereby the device is operative to:
receive at least one extended internet protocol (IP) packet, wherein the at least one extended IP packet comprises a second information element indicative of the QoS requirement of the at least one extended IP packet based on a first information element comprised in at least one IP packet, wherein the at least one IP packet is comprised in the at least one extended IP packet and wherein the at least one IP packet comprises at least one information unit of the ADU and the first information element is indicative of a packaging of information units of the ADU into IP packets;
schedule a transmission opportunity for the at least one IP packet depending on the QoS requirement indicated in the second information element, wherein the transmission opportunity comprises at least one of a time resource and/or a frequency resource of the RAN; and
selectively transmit the at least one IP packet to the end terminal based on the scheduling.

38-46. (canceled)
